(19) United States
(12) Patent Application Publication
(10) Pub. No.: US 2021/0201397 A1
(43) Pub. Date: Jul. 1, 2021

(54) COMPUTER SYSTEM AND COMPUTER-IMPLEMENTED METHOD FOR CREATING A SAVINGS PLAN FOR SPECIFIC PURCHASES

(71) Applicant: 10353744 Canada Ltd., Kitchener (CA)

(72) Inventors: Mark Church, Waterloo (CA); Marcus Edwards, Waterloo (CA); Zachary Packull, Cambridge (CA)

(21) Appl. No.: 17/134,051

(22) Filed: Dec. 24, 2020

Related U.S. Application Data
(60) Provisional application No. 62/954,104, filed on Dec. 27, 2019.

(51) Int. Cl. G06Q 40/02; G06Q 30/06; G06Q 40/00; G06Q 20/10

(52) U.S. Cl. CPC G06Q 40/02; G06Q 20/108; G06Q 40/12; G06Q 30/0637

(57) ABSTRACT

Provided is a computer system and method for automatically electronically transferring funds. The system includes a computer display device displaying a user interface configured to provide the customer with a computer input device to create a savings plan to purchase an item with an indicated price. The system provides that the savings plan is based on a series of electronic fund transfers into a savings account to accumulate electronic funds in the savings account equaling the indicated price. The system also includes a computer server which includes a computer processor configured to determine that the customer does not have sufficient funds and sufficient credit to electronically transfer funds equaling the indicated price. The server also includes a computer readable memory with stored instructions to initiate a purchasing action to purchase the item for the customer when the savings account has sufficient funds to purchase the item.

### TECHNICAL FIELD

The embodiments disclosed herein relate to electronic transactions, and, in particular to systems, methods, and devices for processing financial transactions for budgeting and savings assisting services and provides mechanisms to incorporate an assistance program into the acquisition of goods and services.

### INTRODUCTION

Customers while shopping online frequently desire products that they do not currently have the ability to pay for.

One of the common solutions to this problem is to create a transaction server that may accept information from a credit system linked to the customer in order to pay the vendor of the product or pay the retailer offering the product. In many cases the credit worthiness of the customer is insufficient to provide the necessary loan for the purchase of the product. In other cases, the customer does not wish to be burdened with the interest rate or loss of credit capacity associated with a loan or a purchase though a traditional credit card or credit facility.

What is needed is a new way to process requests for goods and or services that also encourages customers to save for products that they desire without incurring the penalty of interest rates or other layaway fees.

### SUMMARY

Provided is a computer implemented method of providing a customer with an alternative method of purchasing an item, the method comprising: determining that the customer does not have sufficient funds to purchase an item; further determining that the customer does not have sufficient credit to purchase the item; providing a selection mechanism to the customer to create a payment plan wherein the savings plan is based on a series of payments into a savings account, and when the savings account has sufficient funds to purchase the item, a purchasing action is initiated.

Provided is a method of ensuring that an item is available for purchase at an agreed price.

The method may include encouraging responsible spending behaviour, the method comprising

The system may include a savings server.

The system may include a savings plan account.

The system may include an inventory management system.

The method may include implementing Just in Time inventory management control.

The method may include providing to a customer an additional purchase financing option.

The method may include avoiding interest charges for credit purchases of items.

The method may include efficiently providing transaction services for a savings system using at least one server cluster.

The method may include tracking the progress of a plurality of savings plans for a plurality of customers.

The current disclosure proposes an online store front where the retailer offers products directly to customers. In current online stores, retailers typically support a ‘purchase now’ button in close proximity to each product being offered. Often this button is labeled ‘add to cart’ or similar.

In addition to the ‘purchase now’ button, this disclosure proposes that a second button be presented, labeled ‘help me budget for this item’ (‘budget’) or equivalent. The presence of this button may be highlighted under conditions where the customer fails to purchase the item through a credit check failure, or does not have sufficient funds or credit. The budget button is operably connected to a savings administration server that sets up and performs the required functions to save for the purchase.

The ‘budget’ button initiates a workflow that may start a savings account in the customer's name for the purpose of saving for the associated product. The savings account may be started new, or may be an account that is or has been used for saving for other products. In either case, the server system provides an informational interface wherein the customer may observe the status of saving towards the purchase of the product.

Once the customer agrees to set up the savings plan for the purchase of the product, the server system may employ various calculators to help the customer determine the amount and frequency of savings contributions that would be required to achieve the savings goal.

Once the customer agrees to the purchase, the supplier of the product is informed by the server system that a savings plan is in place, and of the agreed purchase price and date that the savings plan will be complete. The supplier then confirms to the server system that the product will be available on that date to the retailer, and that the price will not vary from the agreed pricing. Other details like shipping cost, shipping address, commission, taxes, and duties may be agreed to between the retailer and the supplier. In addition, if the customer may pay for a portion of the product with either cash or credit, the customer may pay the initial portion that they may afford, and then set the savings plan amount to the remainder of the purchase price.

A database record Is created for that purchase and may contain the customer name, customer address, shipping address, and similar information.

In some embodiments, the customer is periodically sent messages reminding them to contribute an amount to their savings goal. The savings amount that the customer responds with may also be a function of several factors, including whether the customer was successfully underbudget in one or more spending categories, whether particular events occurred (birthday, raise, election results), or events with emotional significance like a birthday or the victory of a favourite sports team. A fun, competitive dynamic may also be in place between two or more people saving for items: They may wager friendly ‘bets’ and have the result of that bet be that one of them is required to contribute to their savings plan in the amount of the bet.

In other embodiments, the amount is automatically at least partially calculated from a database of customer expenditures, spending categories, events, and other items. The calculated amount is then either automatically transferred from a spending account to the savings plan, or the customer is requested to authorize the savings amount.

Additionally, in the case where the savings amount falls short of the amount required to stay on track for the savings goal, the shortfall may be requested to be calculated by the savings system to keep the savings plan on track.

In the case where more than one customer is contributing to the savings plan, one or the other or both customers may be sent a message from the savings system to keep the savings plan on track.

The supplier associated with the product that is being saved for may also be informed of the customer's intent to purchase the product on a specific date, or in a date range. The supplier may decide to entice the customer by promising one of a number of benefits with the purchase. One such benefit may be to guarantee that the price of the item will not exceed the agreed purchase price over the savings plan period. Another similar benefit may be to honor any price reductions or sales on the product for the customer. Another benefit may be to honor a ‘lowest price’ guarantee if one of the supplier's competitors offers a lower price for the same item. These functions may be automated by processes in the server system that could scan competitive advertisements or be responsive to notifications from customers that a better price has been found.

Since the supplier has a higher probability for a successfully completed sale that has been fully saved for, the supplier may be able to extend further discounts or bonuses to the customer, since the probability of purchase remorse and return may be significantly lower. The savings system server may track the behaviour of customers and

The supplier may also be able to extend further discounts and bonuses to the customer, as the supplier may implement Just In Time (JIT) inventory management practices to lower the cost of holding the product in inventory.

While useful for end user consumer in B2C (Business to Consumer) transactions, this method may also be useful in B2B (Business to Business) commerce—for example where a bricks and mortar retailer may wish to direct the savings server to ‘save up’ for a particularly expensive showcase item, or a stock group of items for next season.

Since the additional funds are saved in an account that is separate and not used for day to day savings, this savings system may be very useful for secret or surprise gifts. For example, where a customer may not want a second party to know that they are saving for the gift.

In addition, saving funds in this savings system may be useful for situations like shared bank accounts where ‘earmarking’ funds may not be easily remembered by all parties, and the saved funds may be inadvertently spent by another party.

In addition, additional incentives may be realized by using bank accounts that do not charge a maintenance fee, we propose that the savings system utilize a third party stored value account that does not charge a maintenance fee or transaction fees and provides incentives (for example a cash back, loyalty points program, or a power up). In this case the percentage of the transaction that is charged to the supplier as part of the standard card payment fee covers the cost of administering the account for this purpose. Using the additional revenue from loaning the accumulated savings for at least one of: defraying the cost of administering the savings account, providing a discount on the price of the item, providing credits for future purchases, providing reward items for savings plan participation, defraying the warehousing costs for the supplier of selected items.

According to some embodiments there is a computer system for automatically electronically transferring funds, the system includes a computer display device displaying a user interface configured to provide the customer with a computer input device to create a savings plan to purchase an item with an indicated price. The system provides that the savings plan is based on a series of electronic fund transfers into a savings account to accumulate electronic funds in the savings account equaling the indicated price. The system also includes a computer server which includes a computer processor configured to determine that the customer does not have sufficient funds and sufficient credit to electronically transfer funds equaling the indicated price. The server also includes a computer readable memory with stored instructions to initiate a purchasing action to purchase the item for the customer when the savings account has sufficient funds to purchase the item.

The system may provide that the item is at least one of the group comprising goods and services.

The system may provide that the computer readable memory further includes stored instructions to periodically send electronic messages to the customer reminding the customer to contribute to the savings account.

The system may provide that the series of payments includes a contribution amount which is determined by the computer processor based on whether a customer is underbudget in one or more spending categories.

The system may provide that the series of payments includes a contribution amount which is determined by the computer processor based on the occurrence of an event relevant to the customer.

The system of may provide that the series of payments includes a contribution amount which is determined by the computer processor based on a future event specified by the customer.

The system may provide that the series of payments includes a contribution amount which is determined by the computer processor based on whether the customer has won or lost a bet.

The system may provide that the series of payments includes a contribution amount which is related to a periodic charge.

The system may provide that the periodic charge is a pre-authorized charge to a bank account.

The system may also include a computer display of a supplier providing a user interface for monitoring the successful payment of the series of payments.

The system may provide that the computer readable memory has stored instructions to initiate and monitor a shared savings account through a social media channel.

The system may provide that the computer readable memory has stored instructions to implement Just in Time inventory management control.

The system of may provide that the computer readable memory has stored instructions to provide to a customer an additional purchase financing option.

The system may provide that the computer readable memory has stored instructions to avoid interest charges for credit purchases of items.

The system may also include a savings server.

The system may also include a savings plan account.

The system may also include an inventory management system.

According to some embodiments, there is a computer implemented method of automatically electronically transferring funds. The method includes determining on a computer processor whether the customer has sufficient credit to transfer electronic funds equaling an indicated price of an item. The method also includes providing a computer input device for a customer to select a savings plan, wherein the savings plan is based on a series of automatic electronic fund transfers into an savings account to accumulate funds equal to the indicated price. The method also includes storing instructions on a computer readable memory to initiate transfer of electronic funds when the computer processor determines the savings account has sufficient funds to transfer electronic funds equaling the indicated price.

The method may also include determining on a computer processor that the customer does not have sufficient funds to purchase the item.

There may be a computer readable memory having recorded thereon statements and instructions for execution by a computerized electronic funds system to carry out the method of claim 1.

The method may include periodically sending electronic messages from a computer server reminding the customer to contribute to the savings account.

The method may provide that the series of payments includes a contribution amount which is determined by a computer processor based on whether a customer is underbudget in one or more spending categories.

The method may provide that the series of payments includes a contribution amount which is determined by a computer processor based on the occurrence of an event relevant to the customer.

The method may provide that the series of payments includes a contribution amount which is determined by a computer processor based on a future event specified by the customer.

The method may provide that the series of payments includes a contribution amount which is determined by a computer processor based on whether the customer has won or lost a bet.

The method may provide that the series of payments includes a contribution amount which is a related to a periodic charge.

The method may provide that the periodic charge is a pre-authorized charge to a bank account.

The method may provide that the item is at least one of the group comprising goods and services.

The method may also include providing a vendor with a user interface on a computer display device for monitoring the successful payment of the series of payments.

The method may also include initiating and monitoring on a computer processor a shared savings account through a social media channel.

The method may also include implementing on the computer processor just in time inventory management control .

The method may also include providing to a customer on a computer display device an additional purchase financing option.

The method may also include using a computer processor to avoid interest charges for credit purchases of items.

According to some embodiments, there is a computer system for automatically electronically transferring funds, the system includes a customer computer input device to select an item with an indicated price. The system also includes a computer processor connected to the customer input device configured to determine whether the customer has sufficient credit to transfer electronic funds equal to the indicated price. The system also includes a customer computer display connected to the customer input device configured to display at least one additional payment option on a computer display device if the customer has insufficient credit to electronically transfer funds equal to the indicated price of the item. The system provides that the at least one additional payment option includes initiating a savings plan to transfer electronic funds to a savings account to accumulate electronic funds equal to the indicated price at a future date.

The system may also include a computer readable memory with stored instructions to transfer electronic funds from the savings account when the savings account has accumulated electronic funds equal to the indicated price.

The system may provide that the savings plan is based on a series of automatic electronic fund transfers into the savings account according to the savings plan,

The system may provide that the at least one additional payment option includes a partial immediate electronic fund transfer less than the indicated price and a savings plan to transfer electronic funds at a future date to a savings account equaling a remaining amount equal to the difference between the partial immediate fund transfer and the indicated price.

The system may provide that the item is at least one of the group comprising goods and services.

The system may also include a computer readable memory with stored instructions to periodically send messages reminding to the customer computer display device to contribute to the savings account.

The system may provide that the series of electronic fund transfers includes a contribution amount which is determined by the computer processor based on whether a customer is underbudget in one or more spending categories.

The system may provide that the series of electronic fund transfers includes a contribution amount which is determined by the computer processor based on the occurrence of an event relevant to the customer.

The system may provide that the series of electronic fund transfers includes a contribution amount which is determined by the computer processor based on a future event specified by the customer.

The system may provide that the series of electronic fund transfers includes a contribution amount which is determined by the computer processor based on whether the customer has won or lost a bet.

The system may provide that the series of payments includes a contribution amount is a related to a periodic charge.

The method may provide that the periodic charge is a pre-authorized charge to a bank account.

The system may also include a supplier computer display device for monitoring the successful transfer of the series of electronic fund transfers.

The system may provide that the customer computer display device is further configured to display a shared savings account through a social media channel.

The system may also include a computer readable memory with stored instructions to implement just in time inventory management control.

The system may provide that the customer computer display device is further configured to display an additional purchase financing option.

The system may also include a computer readable memory with stored instructions to avoid interest charges for credit purchases of the items.

According to some embodiments, there is a computer implemented method for automatically electronically transferring funds. The method includes providing a computer input device for a customer to select an item with an indicated price. The method also includes determining on a computer processor whether the customer has sufficient credit to transfer electronic funds equal to the indicated price. The method also includes displaying on a customer computer display device at least one additional payment option if the customer has insufficient credit to transfer electronic funds equal to the indicated price. The method provides that the at least one additional payment option includes initiating a savings plan to transfer electronic funds to a savings account for to accumulate electronic funds equal to the indicated price at a future date.

The method may also include storing instructions on the computer readable memory to initiate a purchase of the item when the savings account has sufficient funds to purchase the item.

The method may provide that the savings plan is based on a series of automatic electronic fund transfers into the savings account according to the savings plan,

The method may provide that the at least one additional payment option includes a partial immediate electronic fund transfer less than the indicated price and a savings plan to transfer electronic funds at a future date to a savings account equaling a remaining amount equal to the difference between the partial immediate fund transfer and the indicated price.

The method may provide that the item is at least one of the group comprising goods and services.

The method may also include storing instruction on the computer readable memory to periodically send messages reminding the customer to contribute to the savings account.

The method may provide that the series of payments includes a contribution amount which is determined by the computer processor based on whether a customer is underbudget in one or more spending categories.

The method may provide that the series of payments includes a contribution amount which is determined by the computer processor based on the occurrence of an event relevant to the customer.

The method may provide that the series of payments includes a contribution amount which is determined by the computer processor based on a future event specified by the customer.

The method may provide that the series of payments includes a contribution amount which is determined by the computer processor based on whether the customer has won or lost a bet.

The method may provide that the series of payments includes a contribution amount is a related to a periodic charge.

The method may provide that the periodic charge is a pre-authorized charge to a bank account.

The method may also include providing a supplier with a computer display device for monitoring the successful transfer of the series of electronic fund transfers.

The method may also include storing instructions on the computer readable memory to initiate and monitor on a computer display device a shared savings account through a social media channel.

The method may also include storing instructions on the computer readable memory to implement just in time inventory management control.

The method may also include displaying on the computer display device to a customer an additional purchase financing option.

The method may also include storing on the computer readable memory instructions to avoid interest charges for credit purchases of the items.

There may be a computer readable memory having recorded thereon statements and instructions for execution by a computerized electronic funds system to carry out the method.

According to some embodiments, there is a computer system for automatically electronically transferring funds. The system includes a computer processor configured to determine whether a customer has sufficient funds and sufficient credit to transfer electronic funds equaling an indicated price of an item. The system also includes a customer computer input device configured to select a partial payment option to electronically transfer a partial amount of electronic funds equal to less than the indicated price, wherein the partial amount is based on the funds and credit the customer has available. The customer computer input device is also configured to provide an option to the customer to create a savings plan, wherein the savings plan is based on a series of automatic electronic fund transfers into a savings account equaling the difference between the partial amount and the indicated price. The system also includes a computer readable memory with stored instructions to initiate a transfer of electronic funds when the savings account accumulates electronic funds equal to the difference between the partial amount and the indicated price.

According to some embodiments there is a computer implemented method for automatically electronically transferring funds. The method includes determining on a computer processor that the customer does not have sufficient funds and sufficient credit to transfer electronic funds equaling an indicated price of an item. The method includes providing on a computer input device to a customer to select an option to electronically transfer a partial amount of electronic funds equal to less than the indicated price. The method provides that a partial amount is based on the funds and credit the customer has available. The method also includes providing a computer input device to the customer to create a savings plan, wherein the savings plan is based on a series of automatic electronic fund transfers into a savings account equaling the difference between the partial amount and the indicated price. The method also includes storing instructions on a computer readable memory to initiate a transfer of electronic funds when the savings account accumulates electronic funds equal to the difference between the partial amount and the indicated price.

There may be a computer readable memory having recorded thereon statements and instructions for execution by a computerized electronic funds system to carry out the method.

According to some embodiments, there is a computer system for electronically transferring funds. The system includes a customer computer display device configured to display a plurality of payment types for each item with an indicated price, wherein at least one payment type is a savings plan. The system provides that the savings plan is based on a series of automatic electronic fund transfers into a savings account accumulatively equaling the indicated price. The system also includes a customer computer input device configured to select each item to purchase using the savings plan. The system also includes a computer server with a computer readable memory with stored instructions to automatically electronically transfer funds to the savings account according to the savings plan and cumulatively equal to the indicated price and automatically electronically transfer electronic funds from the savings account when the savings account has accumulated funds equaling the indicated price.

The system may provide that the computer display device displays an option to immediately transfer electronic funds equal to the indicated price of each item not selected for purchase with the savings plan.

The system may provide that the computer display device is configured to display whether an item is eligible for purchase with a savings plan.

According to some embodiments, there is a computer implemented method of electronically transferring funds. The method includes displaying on a customer computer display device a plurality of payment types for each item with an indicated price, wherein at least one payment type is a savings plan. The method includes the savings plan is based on a series of automatic electronic fund transfers into a savings account cumulatively equaling the indicated price. The method also includes providing a customer computer input device to select each item to purchase using the savings plan. The method also includes automatically electronically transferring funds at a future time according to the savings plan and equal to the indicated price. The method also includes storing instructions on a computer readable memory to automatically electronically transfer electronic funds from the savings account when the savings account has accumulated funds equaling the indicated price.

The method may also include immediately transferring electronic funds equal to an indicated price of each item not selected for purchase with the savings plan.

The method may provide that the item is identified on a computer display device as being eligible for purchase with a savings plan.

There may be a computer readable memory having recorded thereon statements and instructions for execution by a computerized electronic funds system to carry out the method.

According to some embodiments, there is a computer system for automatically electronically transferring funds for physical transfer of an item, the system includes a customer computer device configured to select with an input device the item on a customer computer. The customer computer device is also configured to display with a display device an indicated price for the item that is valid within a time period. The customer computer device is also configured to display with the display device a customer savings plan to make electronic fund transfers to a savings account to accumulate electronic funds equal to an indicated price. The system also includes a computer server configured to automatically electronically transferring funds according to the savings plan and equal to the indicated price within the time period. The computer seryer is also configured to provide an electronic guarantee to the customer computer that the item will be available at the indicated price at the end of the valid time period.

The system may provide that the electronic guarantee includes instructions stored on a computer readable memory to match a lowest price offer if a competitor offers the same item at a lower price.

The system may provide that the guarantee includes instructions stored on a computer readable memory to match a lower price if the vendor of the item reduces the price of the item.

According to some embodiments there is a computer implemented method of automatically electronically transferring funds for physical transfer of an item. The method includes providing an input device on a customer computer to select the item on a customer computer. The method also includes displaying on a display of the customer computer an indicated price for the item that is valid within a time period. The method also includes displaying, on the display of the display of the customer computer, a customer savings plan to make electronic fund transfers to a savings account to accumulate an indicated price. The method also includes automatically electronically transferring funds according to the savings plan and equal to the indicated price within the time period. The method also includes providing an electronic guarantee to the customer computer that the item will be available at the indicated price at the end of the valid time period. The method also includes physically sending the item to the customer at the end of the valid time period.

The method may provide that the guarantee includes instructions stored on a computer readable memory to match a lowest price offer if a competitor offers the same item at a lower price.

The method may provide that the guarantee includes instructions stored on a computer readable memory to match a lower price if the vendor of the item reduces the price of the item.

There may be a computer readable memory having recorded thereon statements and instructions for execution by a computerized electronic funds system to carry out the method.

According to some embodiments there is a computer implemented method of ensuring that an item will be available at a specific time in the future. The method includes providing a customer computer input device for selecting the item. The method also includes displaying on a computer display device an indicated price for the item that is valid within a time period. The method also includes displaying on the customer display device an offer to purchase the time with a savings plan. The method may provide that the savings plan includes automatic electronic fund transfers to a savings account to accumulate the indicated price. The method may provide that the savings plan is structured to accumulate funds equal to the indicated price within the valid time period. The method also includes storing instructions on a computer readable memory for a production and delivery schedule to make the item available at the end of the production and delivery schedule. The method also includes determining on the computer processor a probable date on which the savings account will accumulate funds equal to the indicated price based on the savings plan. The method also includes physically sending the item to the customer at the end of the valid time period

The method may also include adjusting the production and delivery schedule on the computer processor if the savings account accumulates the indicated price ahead of the probable date.

There may be a computer readable memory having recorded thereon statements and instructions for execution by a computerized electronic funds system to carry out the method.

According to some embodiments there is a computer system for ensuring that an item will be available at a specific time in the future. The system includes a customer computer input device configured to select the item. The system includes a customer computer display device configured to display an indicated price for the item that is valid within a time period. The customer computer display device is also configured to display an offer to purchase the time with a savings plan. The system provides that the savings plan includes automatically transferring electronic funds to a savings account to accumulate the indicated price. The system provides that the savings plan is structured to accumulate funds equal to the indicated price within the valid time period. The system also includes a computer readable memory with stored instructions for a production and delivery schedule to make the item available at the end of the production and delivery schedule. The system also includes a computer processor configured to determine a probable date on which the savings account will accumulate funds equal to the indicated price based on the savings plan.

The system may provide that the computer processor is further configured to adjust the production and delivery schedule stored on the computer readable memory if the savings account accumulates the indicated price ahead of the probable date.

According to some embodiments there is a computer implemented method for increasing transactional efficiency of an electronic transaction. The method includes providing a customer input device to select an item. The method also includes indicating on a customer display device an indicated price for the item that is valid for within a time period. The method also includes providing on the customer input device to select one of a plurality of payment types for each selected item, wherein at least one of the payment types is a savings plan. The method also includes providing on the customer input device to create a savings plan for the each selected item for payment by the savings plan. The method provides that the savings plan is based on a series of automatic electronic fund transfers into a savings account. The method also includes loaning to a third party using a computer server electronic funds equal to the accumulated electronic funds in the savings account;

The method may also include using revenue generated from loaning the accumulated electronic funds for at least one of the group comprising: defraying the cost of administering the savings account, providing a discount on the price of the item, providing credits for future purchases, providing reward items for savings plan participation, and defraying the warehousing costs for the supplier of selected items.

There may be a computer readable memory having recorded thereon statements and instructions for execution by a computerized electronic funds system to carry out the method.

According to some embodiments there is a computer system for increasing transactional efficiency of an electronic transaction, the system includes a customer input device configured to, select an item, select one of a plurality of payment types for each selected item, wherein at least one of the payment types is a savings plan, and create a savings plan for the each selected item for payment by the savings plan, wherein the savings plan is based on a series of automatic electronic fund transfers into a savings account. The system also includes a customer display device configured to display an indicated price for the item that is valid within a time period. The system also includes a computer server configured to loan electronic funds to a third party equal to the accumulated electronic funds in the savings account.

The system may provide that the computer server is further configured to use revenue generated from loaning the accumulated electronic funds for at least one of the group comprising: defraying the cost of administering the savings account, providing a discount on the price of the item, providing credits for future purchases, providing reward items for savings plan participation, and defraying the warehousing costs for the supplier of selected items.

According to some embodiments there is a computer implemented method for saving for transferring electronic funds for bulk inventory. The method comprising includes providing a customer computer input device to select an item. The method also includes providing the customer computer input device to select a quantity of the item. The method also includes providing the customer computer input device to select a date on which the quantity of item is to be available to the supplier. The method also includes displaying an indicated price for the item on a customer computer display device that is valid within a time period. The method also includes displaying on the customer computer display device an option to automatically electronically transfer funds to a savings account according to a savings plan to accumulate the indicated price, wherein the savings plan is structured to accumulate funds equal to the indicated price within the valid time period. The method also includes providing an electronic guarantee to the customer that the quantity of items will be available at the indicated price at the end of the valid time period. The method also includes physically sending the item to a customer at the end of the valid time period.

There may be a computer readable memory having recorded thereon statements and instructions for execution by a computerized electronic funds system to carry out the method of claim 93.

According to some embodiments there is a computer system for saving for transferring electronic funds for bulk inventory. The system includes a customer computer input device configured to select an item, select a quantity of the item, select a time period in which the quantity of item is to be available to the supplier, and select an option to automatically electronically transfer funds to a savings account according to a savings plan to accumulate the indicated price. The system provides that savings plan is structured to accumulate funds equal to the indicated price within the time period. The system also includes a customer computer display device connected to the customer input device, the customer computer display configured to display an indicated price for the item that is valid within the time period and a computer server configured to send an electronic guarantee to the supplier that the quantity of items will be available at the indicated price at the end of the valid time period.

According to some embodiments there is a computer implemented method for accumulating electronic funds for an item with multiple customers. The method includes displaying on a customer computer display device an item with an indicated price. The method includes providing a customer computer input device to create a savings plan. The method provides that the savings plan is based on automatically electronically transferring funds to a joint savings account to accumulate a savings goal equal to the indicated price. The method includes providing the customer computer input device to send an electronic invite to at least one additional customer to join the savings plan. The method includes providing at least one additional client computer input device to accept the invite and select an electronic funds transfer amount and a frequency of electronic funds transfer to the joint savings account. The method includes determining on a computer processor the balance of the respective electronic fund transfers between the client and the additional client of the to the joint savings account. The method includes displaying information on a customer computer display device regarding the progress to the savings goal. The method includes storing instructions on computer readable memory to transfer funds from the joint savings account when the savings account accumulates funds equal to the savings goal.

There may be a computer readable memory having recorded thereon statements and instructions for execution by a computerized electronic funds system to carry out the method.

According to some embodiments there is a computer system for accumulating electronic funds for an item with multiple customers. The method includes a customer computer display device configured to display an item with an indicated price. The system also includes a customer computer device configured to create a savings plan, wherein the savings plan is based on automatically electronically transferring funds to a joint savings account to accumulate a electronic funds to reach a savings goal equal to the indicated price. The customer computer device is also configured to send an electronic invite to at least one additional customer device to join the savings plan. The customer computer device is also configured to display information regarding the progress to the savings goal. The system also includes at least one additional customer computer device configured to accept the electronic invite and select an electronic funds transfer amount and a frequency of electronic funds transfer to the joint savings account. The system also includes a computer server connected to the customer computer device and at least one additional customer computer device, the computer server configured to determine the balance of the respective electronic fund transfers between the customer computer device and the at least one additional customer computer device of the to the joint savings account. The computer server is also configured to transfer funds from the joint savings account when the savings account accumulates funds equal to the savings goal.

According to some embodiments there is a merchant savings server for enabling a plurality of clients to save for a common savings goal. The server includes a receiving module configured to receive from a first client device an electronic invite to join a savings plan to transfer electronic funds to a joint savings account. The receiving modules is also configured to receive an electronic acceptance from the at least one additional client device. The system provides that the electronic acceptance includes an electronic funds transfer amount and a frequency to transfer the electronic funds to the joint savings account. The system also includes a transmitting module configured to send the electronic invite to at least one additional client device. The system also includes a judgement module configured to determine a balance the respective electronic fund transfers of the client device and the at least one additional client device to the joint savings account. The system provides that the savings plan is based on a series of electronic fund transfer into the savings account to accumulate funds equal to an indicated price of an item. The judgement module is also configured to automatically transfer electronic funds from the savings account when the savings account has accumulated electronic funds equal to the indicated price of the item.

The server may provide that the transmitting module is configured to send information to the client device regarding the progress to the savings plan goal;

The server may provide that the transmitting module is configured to send status information to a supplier regarding the status of the savings plan;

The server may provide that the transmitting module is configured to send information to the at least one additional client device regarding the progress to the savings plan goal;

The server may provide that the receiving module and transmitting module is configured to use a communications protocol for communication between the client device and the server.

The server may provide that the communications protocol is at least one the group comprising of JSON, SOAP, XML, and GraphQL.

The server may provide that the receiving module and transmitting module is configured to use a communications protocol for the server communications with a customer database, wherein the communications protocol is at least one of the group comprising: Open DataBase Connectivity protocol (ODBC), the Java DataBase Connectivity protocol (JDBC), and Microsoft's OLE-DB protocol.

The server may provide that the receiving module and transmitting module is configured to use a communications protocol for communication between the server and a client spending account.

There server may provide that the communications protocol is at least one of the group comprising SWIFT and ISO20022.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a traditional web-based product purchasing system, in accordance with an embodiment.

FIG. 2 a web-based product purchasing system including a budget function.

FIG. 3 is a diagram of the transaction flows in the enhanced budgeting product purchasing system.

FIG. 4 is a chart showing several of the different savings strategies that may be used in the enhanced budgeting product purchasing system.

FIG. 5 is an exemplary user interface for setting the parameters of the savings system.

FIG. 6 shows messaging types and flow to communicate between the savings administration server and the customer.

FIG. 7 shows a possible implementation where more than one customer is saving for a purchase.

FIG. 8 shows an implementation where the Merchant Savings Server is composed of a cluster of microservice servers.

FIG. 9 illustrates the different protocols that enable communication between all of the system's elements.

FIG. 10 illustrates an embodiment where the Merchant Savings Server is composed of a number of distributed server clusters.

FIG. 11 Shows an implementation of a customer Login Screen

FIG. 12 illustrates a sample of a customer savings setup screen: source account access number entry.

FIG. 13 Shows a sample of customer Savings Plan Setup Screen: Savings Item Setup

FIG. 14 Illustrates a customer Savings Plan Setup Screen: Savings Plan Registration Form

FIG. 15 illustrates a sample of Savings Plan initiation Screen: Savings Plan Offer for Insufficient Funds/Credit

FIG. 16 Shows an example of a supplier administrator landing screen for setting parameters of the savings plan

FIG. 17 shows an example of a supplier administrator landing screen for management of current savings plan offers.

FIG. 18 illustrates an example of a customer User Interface to the online store

FIG. 19 shows a example of a customer User Interface to the online store and information on savings plan options.

FIG. 20 illustrates an example of a customer User Interface screen for selection of items included in a savings plan

FIG. 21 illustrates an example of a supplier user interface to set up some of the available options for a savings plan.

FIG. 22 illustrates an example of a supplier user interface to set up global options.

FIG. 23 illustrates an example of a supplier user interface to set up graphql API options.

FIG. 24 illustrates an example of a supplier user interface to install the savings plan plugin.

FIG. 25 illustrates an example of a customer user interface for completing the order.

FIG. 26 illustrates an example of a vendor user interface for monitoring the order.

FIG. 27 illustrates an example of a vendor user interface for setting parameters of a savings plan.

FIG. 28 illustrates an example of a customer user interface for confirming the order.

FIG. 29 illustrates an example of an email customer interface for the order.

FIG. 30 illustrates an example of a vendor tracking interface for the order.

FIG. 31 illustrates an example of a vendor tool for testing savings plan system with an order.

FIG. 32 illustrates an example of a vendor order processing console.

FIG. 33 is a block diagram of a network system, in accordance with an embodiment.

FIG. 34 is a block diagram of a device of the system, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

The methods described herein are not contemplated to be performed without a computer and a system of computers.

Each program is preferably implemented in a high-level procedural or object-oriented programming and/or scripting language to communicate with a computer system. However, the programs are implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Embodiments described herein provide a system and method for enabling the purchaser of a product or service to be guided to an effective and appropriate savings plan to complete that purchase. The product purchase transaction and the savings plan for that product are linked and managed through a Merchant Savings Server, providing numerous advantages to the purchaser, the supplier, and the associated financial institutions that hold the savings plan funds and the spending account.

The purchaser (customer), is enabled by being provided with access to a Merchant Savings Server to reserve and guarantee the future option to purchase an item, collection of items, or services (herein, item) that they would not otherwise be able to purchase. Typical reasons for an inability to purchase may be a lack of funds sufficient to purchase the item, a lack of credit capacity to purchase the item, or both. In addition, the Savings Plan System described herein may be configured to provide assurances to the purchaser that the desired item will remain available while the savings plan is active, and will not unfavourably change in price.

For the supplier of the item, the assurance of a motivated purchaser improves the confidence toward a successful sale. In addition, the supplier may benefit from the additional time afforded by the Savings Plan System to schedule the ordering of the item, and thus reduce storage and capital costs for holding inventory.

For the financial institutions holding either the Savings Plan Funds or the Spending Account, they benefit from increasing their brand messaging to the purchaser. In addition, revenues may be realized from the interest on the Savings Plan Funds, and from transaction commissions for purchasing the item when sufficient funds have accumulated.

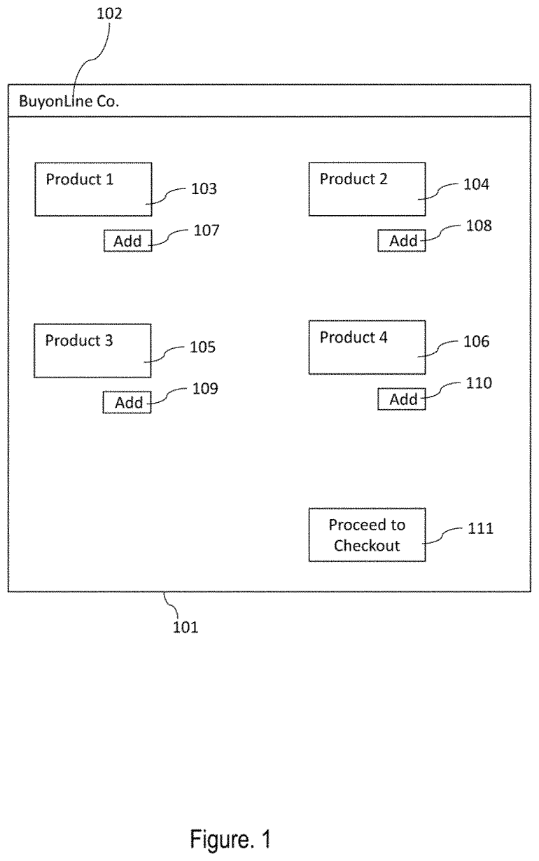

FIG. 1 represents a traditional web-based storefront or product purchasing system. The user is presented through their web browser 101, with images that represent various products that are offered for sale. Often such an interface will include the name of the vendor 102, and several other messages, including logos, advertisements, special offers, navigation controls, and user account status (all not shown). Shown are four representative products offered for sale, 103,104,105,106. These areas of web browser typically display images of the product, product specifications, pricing, and other similar information intended to entice the user to buy. In addition, shown are four corresponding ‘buttons’ or activation areas 107,108,109,110 corresponding to the images of products for sale. Normally, the activation areas are associated with the product image to which they are closest. Often these buttons are labeled with text similar to ‘buy now’ or ‘add to cart’. Clicking on the button normally adds the product to the ‘shopping cart’ of the user. Also on the storefront is typically another button labeled ‘proceed to checkout’ or similar 111. This button allows the user to progress to the next stage of the purchase, where further information related to the transaction is gathered.

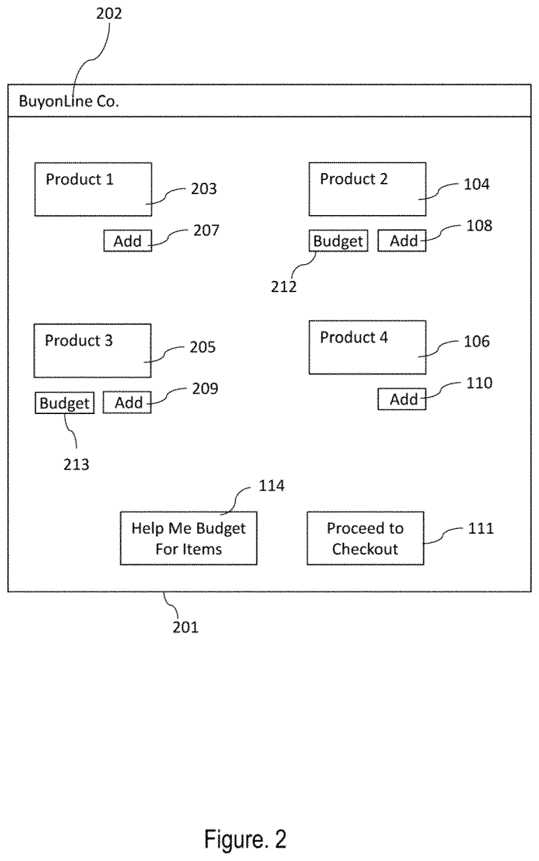

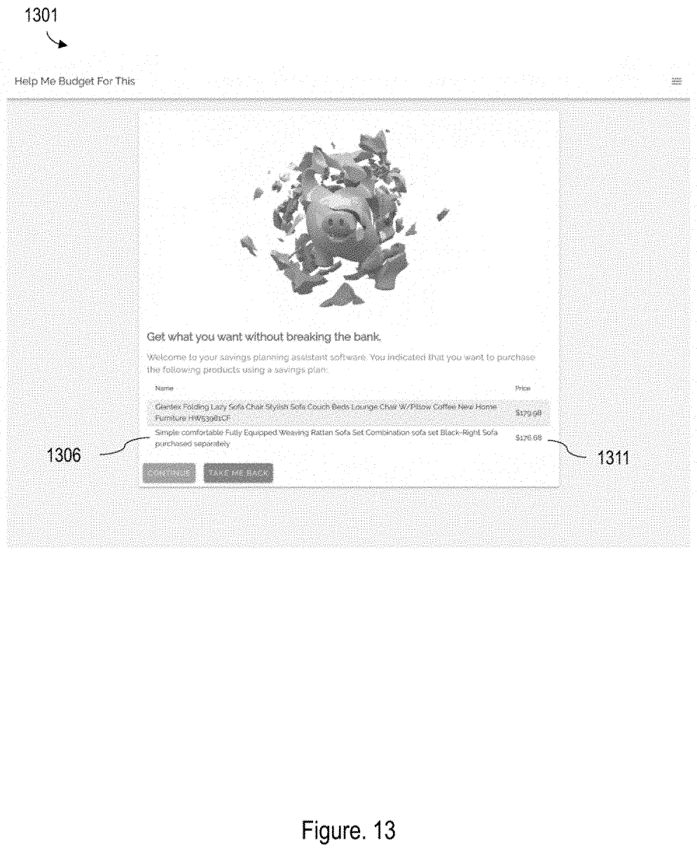

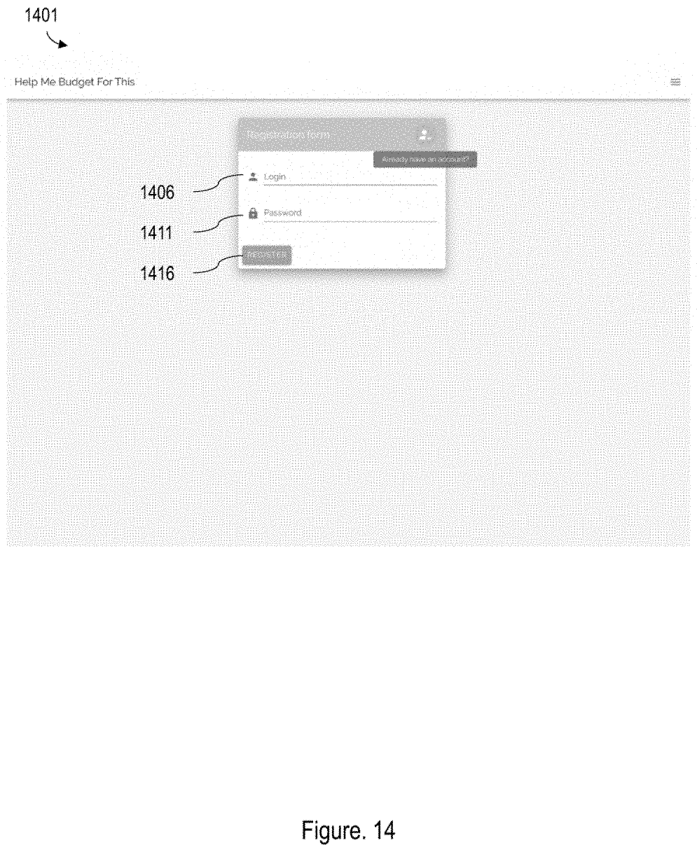

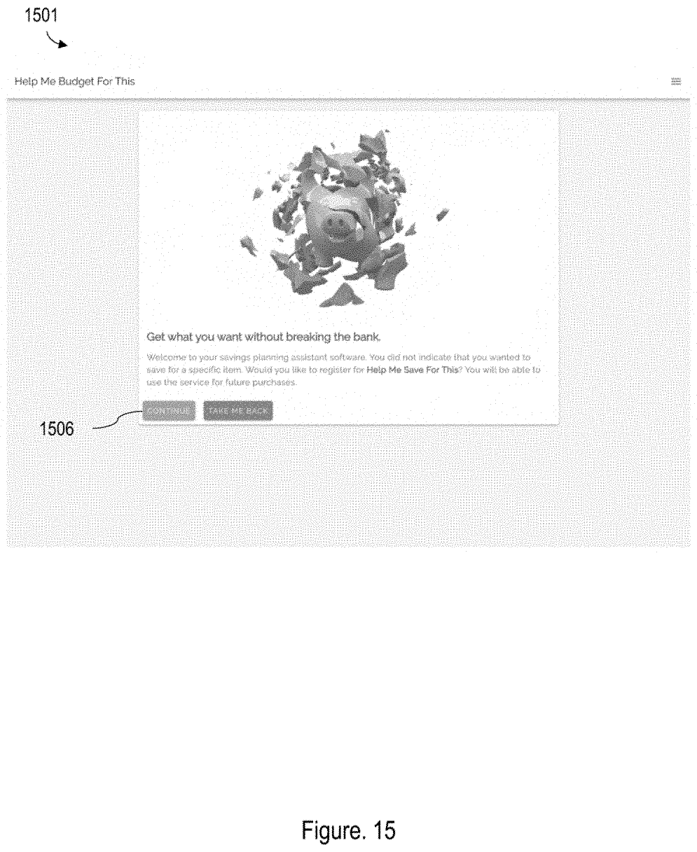

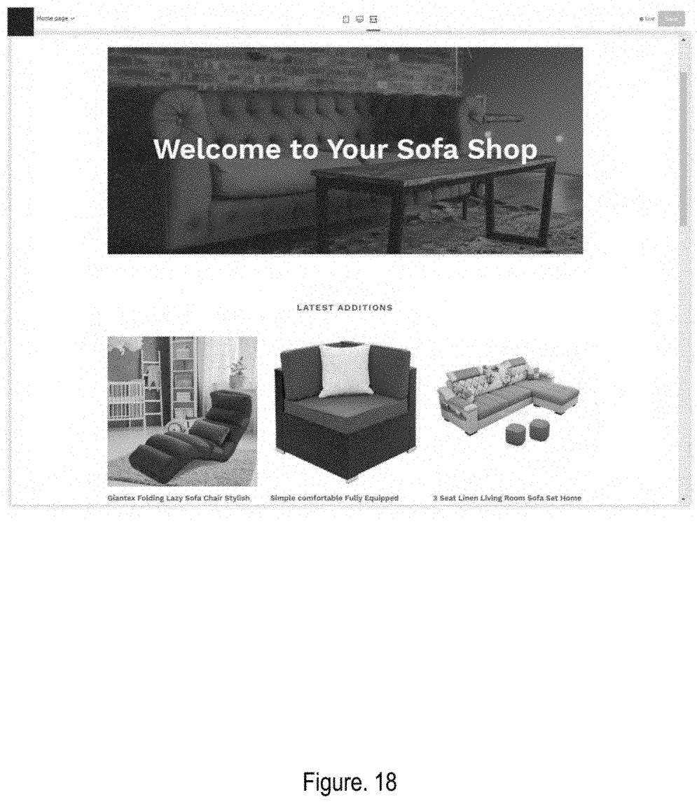

FIG. 2 represents a traditional web-based storefront or product purchasing system with a Savings Plan System. The user is presented through their web browser 201, with images that represent various products that are offered for sale, such as in FIGS. 18, 19 and 20. Often such an interface will include the name of the vendor 202, and several other messages, including logos, advertisements, special offers, navigation controls, and user account status (all not shown). Shown are four representative products offered for sale, 203,204,205,206. These areas of web browser typically display images of the product, product specifications, pricing, and other similar information intended to entice the user to buy. In addition, shown are four corresponding ‘buttons’ or activation areas 207,208,209,210 corresponding to the images of products for sale. Normally, the activation areas are associated with the product image to which they are closest. Often these buttons are labeled with text similar to ‘buy now’ or ‘add to cart’. Clicking on the button normally adds the product to the ‘shopping cart’ of the user. Also on the storefront is typically another button labeled ‘proceed to checkout’ or similar 111. This button allows the user to progress to the next stage of the purchase, where further information related to the transaction is gathered, including a confirmation of items for the savings plan as shown in FIG. 13. If the savings plan is not set up, there may also be a registration to the savings plan as shone in FIG. 14. In addition, a path to the savings system may also occur if an attempted purchase was declined due to insufficient funds, as in FIG. 15.

In addition to these elements, the Savings Plan System adds at least an additional button 214, labeled ‘Help me budget for this’ (budget button) or equivalent. The items selected for purchase may be collected in a traditional cart for a subsequent purchasing process. Similarly, items selected for a savings plan with the budget button may be collected in a similar cart for a subsequent budgeting process. The user may know before selecting any particular item, whether it is within their means to purchase, or whether they are willing to release funds or incur indebtedness to purchase the item at this time. In this case, the user would select the budget button for that particular item and proceed to the subsequent step to begin the budgeting process. In other cases, the user may not be sufficiently aware of their credit situation, and may attempt to purchase the item, only to be unable to complete the transaction due to lack of funds or lack of credit. In such cases, the user may be prompted to continue to purchase the item, but through the budgeting process.

In some embodiments there is a computer system for automatically electronically transferring funds, the system includes a computer display device displaying a user interface configured to provide the customer with a computer input device to create a savings plan to purchase an item with an indicated price. The system provides that the savings plan is based on a series of electronic fund transfers into a savings account to accumulate electronic funds in the savings account equaling the indicated price. The system also includes a computer server which includes a computer processor configured to determine that the customer does not have sufficient funds and sufficient credit to electronically transfer funds equaling the indicated price. The server also includes a computer readable memory with stored instructions to initiate a purchasing action to purchase the item for the customer when the savings account has sufficient funds to purchase the item.

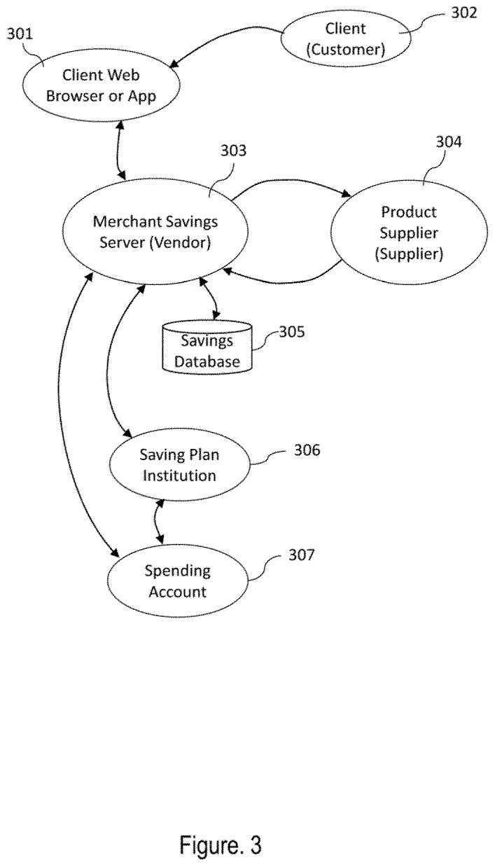

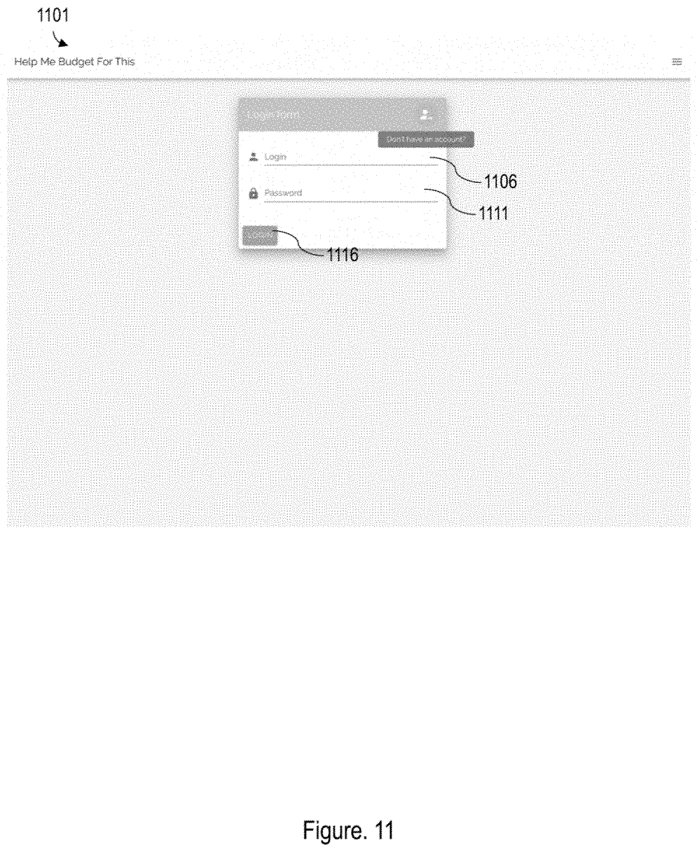

FIG. 3 shows the entities involved in the Savings Plan System, with various messaging paths between the entities. The client 302 is the operator of the system. In one embodiment the client or customer is a natural human, such as a retail customer of an online business. In other embodiments, the client could be an automated purchasing agent of a corporation, an algorithmic stock trading application, a procurement processor, or similar amalgamation or processing entity. The client web browser 301, interfaces with the client 302, and receives directed input to accomplish the tasks required by the client. Many implementations will require a form of user authentication, such as a password entry shown in FIG. 11. In one embodiment, the client web browser could be a standard web user interface connected to the internet, and operated by the client's control of a mouse and keyboard.

The Merchant Savings Server 303, is operably connected to the client web browser 301 via HTTPS, and in one embodiment, may perform server-side rendering to serve the rendered web pages to the client web browser. The Merchant Savings Server may also receive data and requests to execute algorithms from the client web browser 301, to collect the necessary information to process product purchase requests and budget process requests. In some embodiments the server that delivers or ‘serves’ the web page to the client web browser 301 is a different physical computer or a part of a different network, such as part of a larger online shopping system such as Shopify ®.

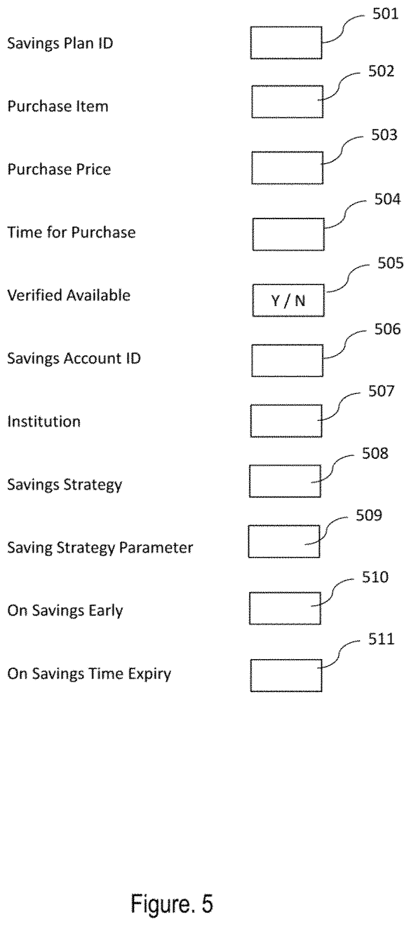

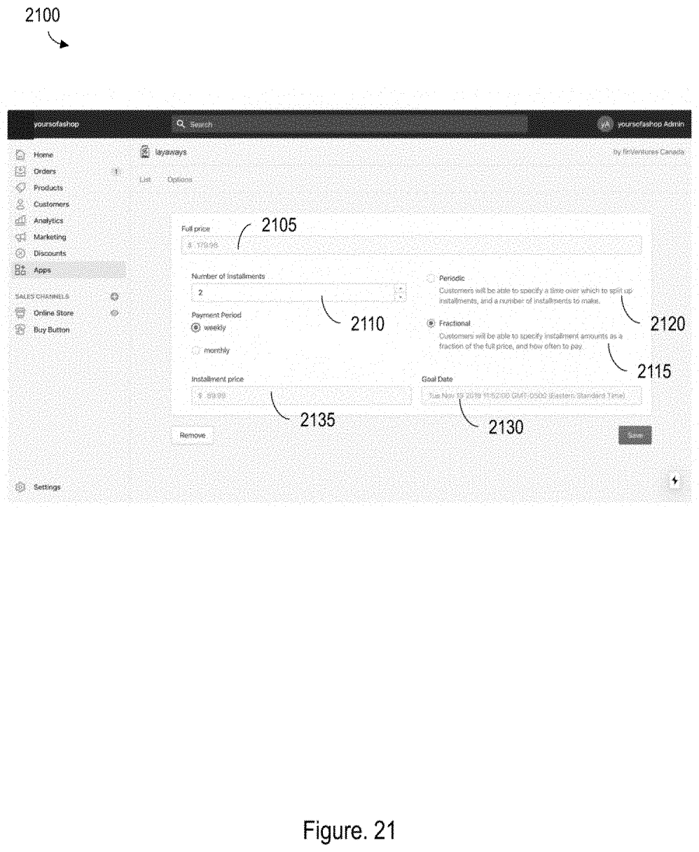

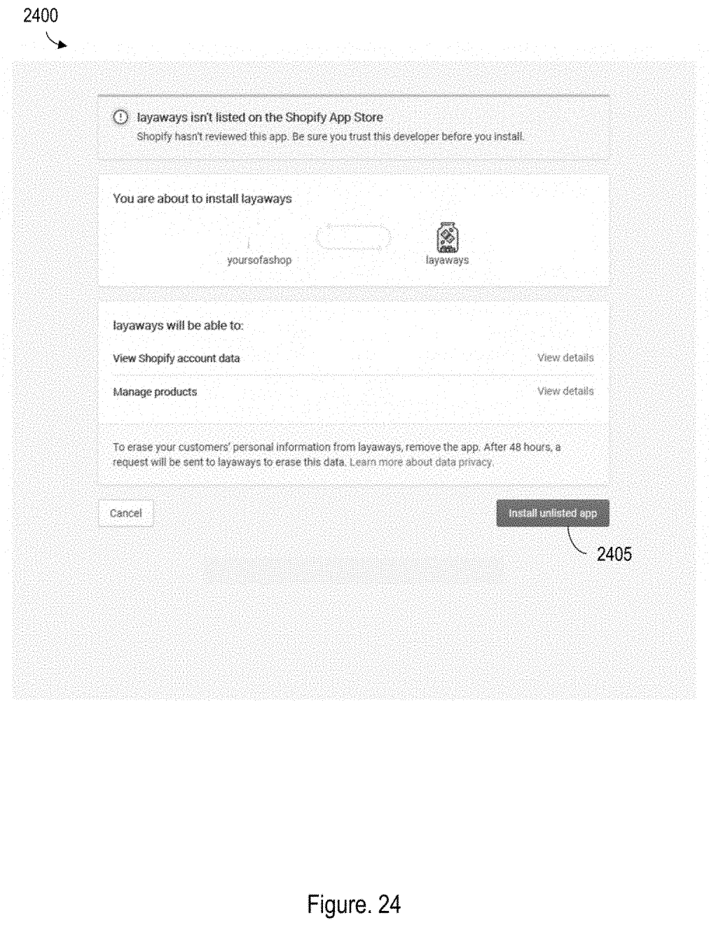

The Merchant Savings Server 303 is also operably connected to the Savings Database 305.The Savings Database records the data required to manage a savings plan for a customer to set up, utilize, contribute to, interrogate the status of, and complete a purchase from a budgeting process. One example of a possible data set managed by the Savings Database is shown in detail in FIG. 5, and further illustrated in FIGS. 21, 22 and 23. The Savings Database may be connected to the Merchant Savings Server through several well-known means, including a directly accessible hard drive, network accessible storage, or a remote database accessible through a data access protocol such as SWIFT or ISO20022. The mechanism through which the Vendor communicates to the Merchant Savings Server may be through a plugin, as illustrated in FIG. 24.

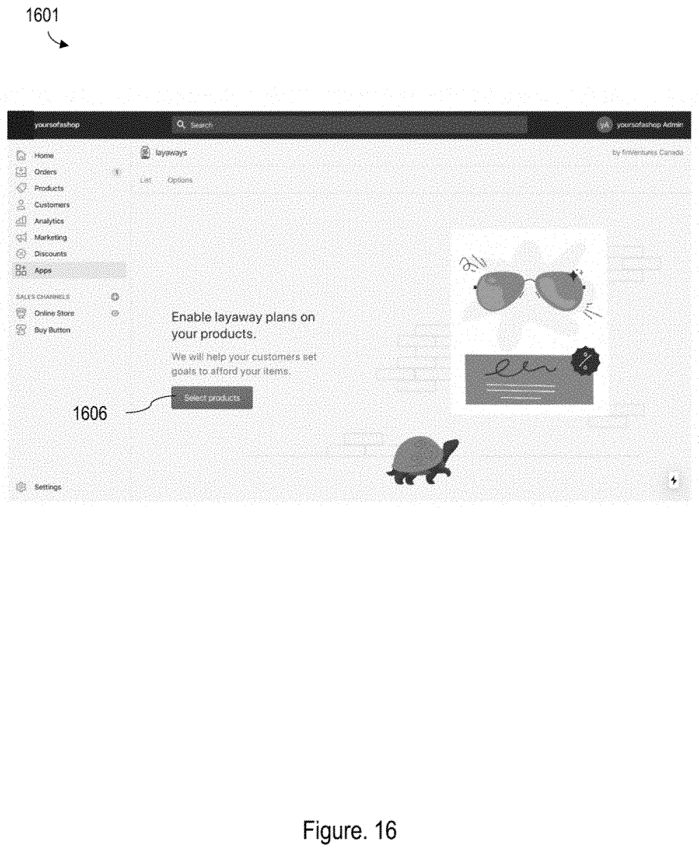

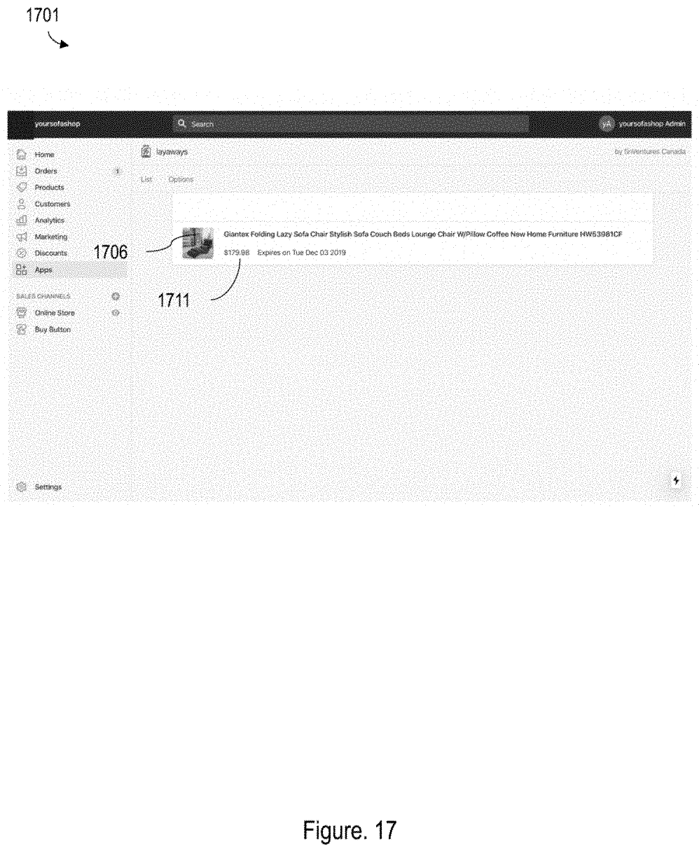

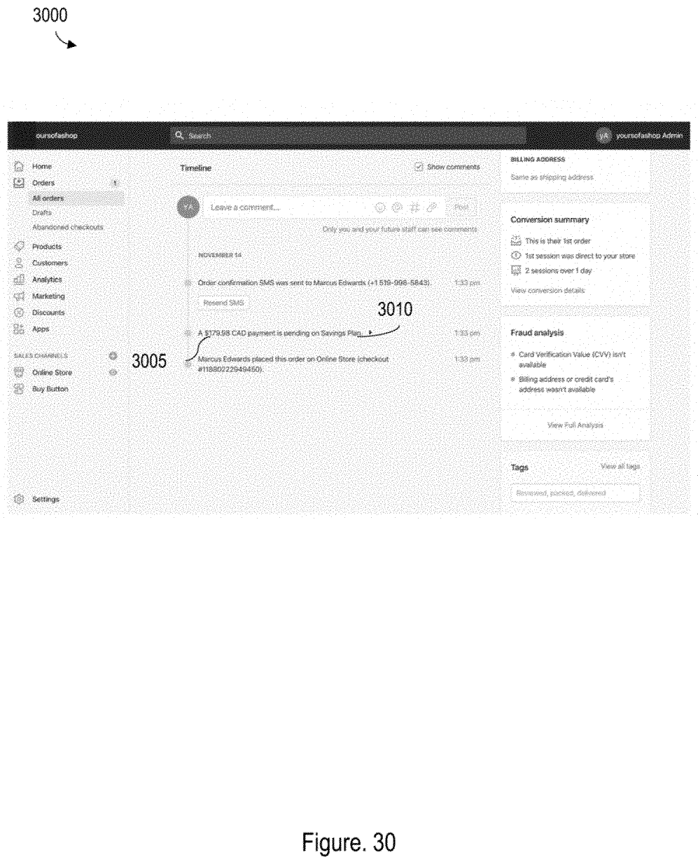

The Product Supplier 304, is communicatively connected to the Merchant Savings Server. In one embodiment, the connection is a data connection over the internet through a connection protocol such as TCP/IP or a secure internet connection for example through a VPN. The transaction protocol for such communications could be a transaction protocol such as ISO20022. The Merchant Savings Server provides information to the Product Supplier regarding either a product purchase either directly with available funds or with a credit facility such as a credit card, or to give notification of the start of a budgeting process to purchase the item. Normally, a vendor would set up the parameters of savings plans through an interface such as the one shown in FIG. 16 and FIG. 17. Tracking of the order and Savings Plan progress may be tracked through an interface similar to the one shown in FIG. 30.

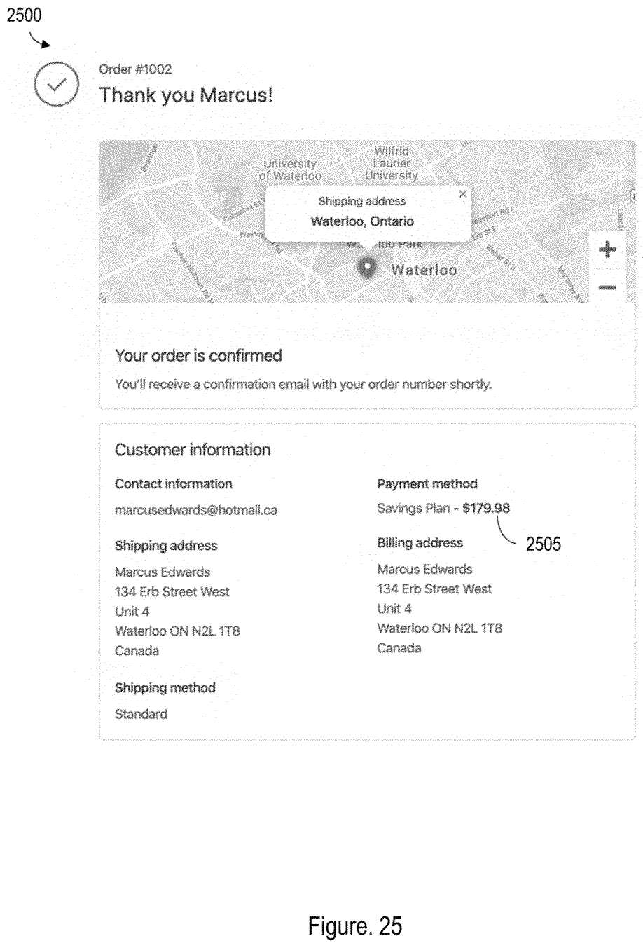

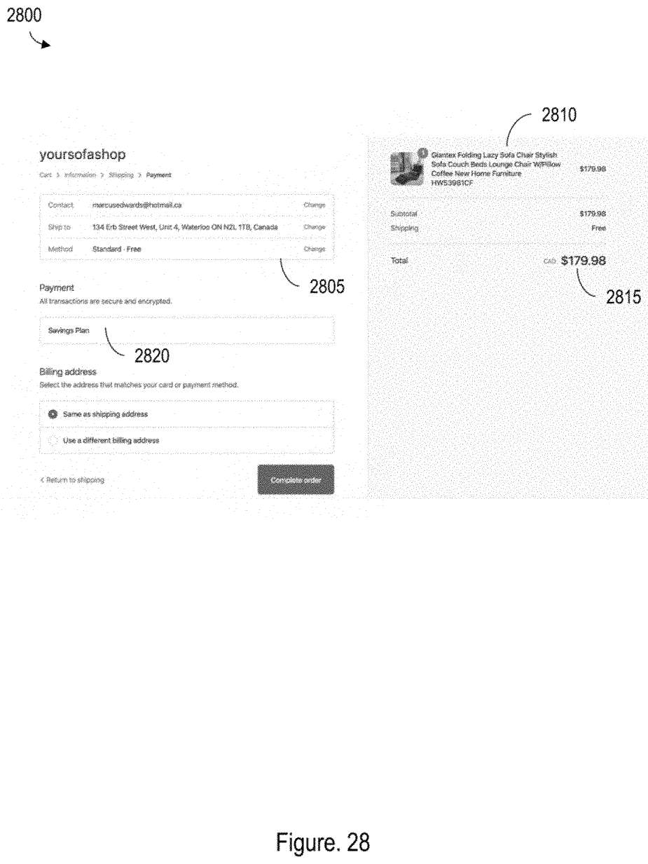

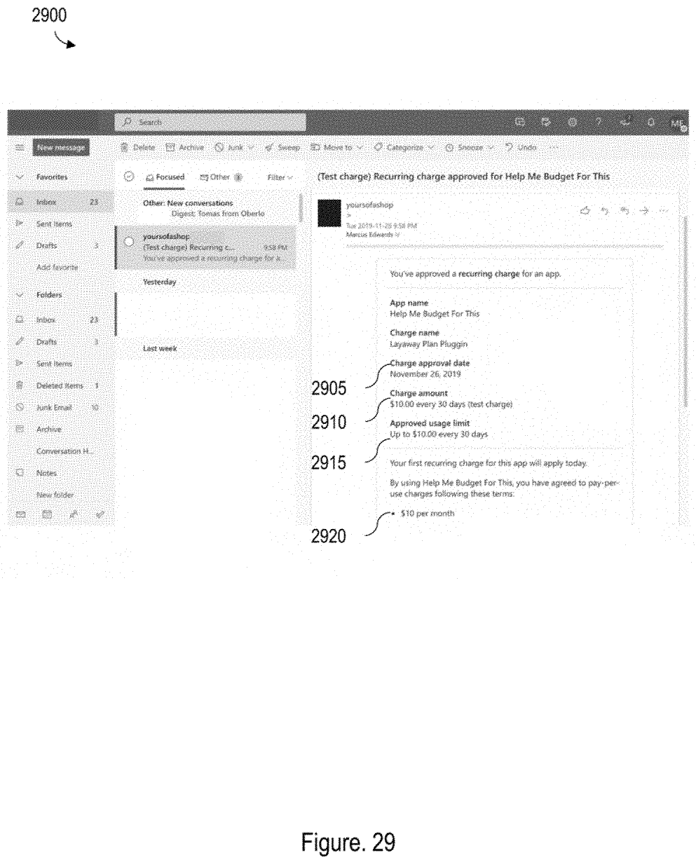

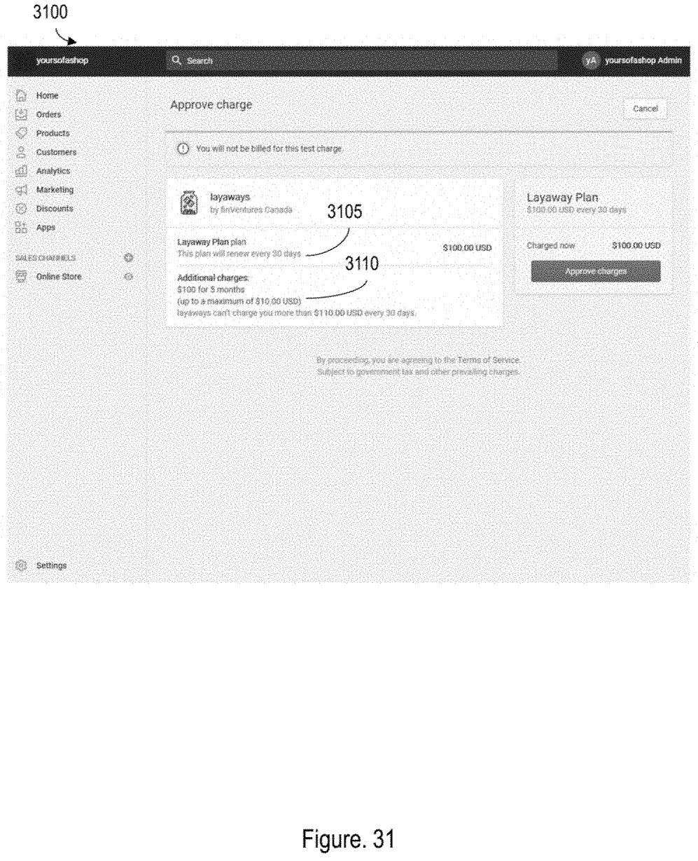

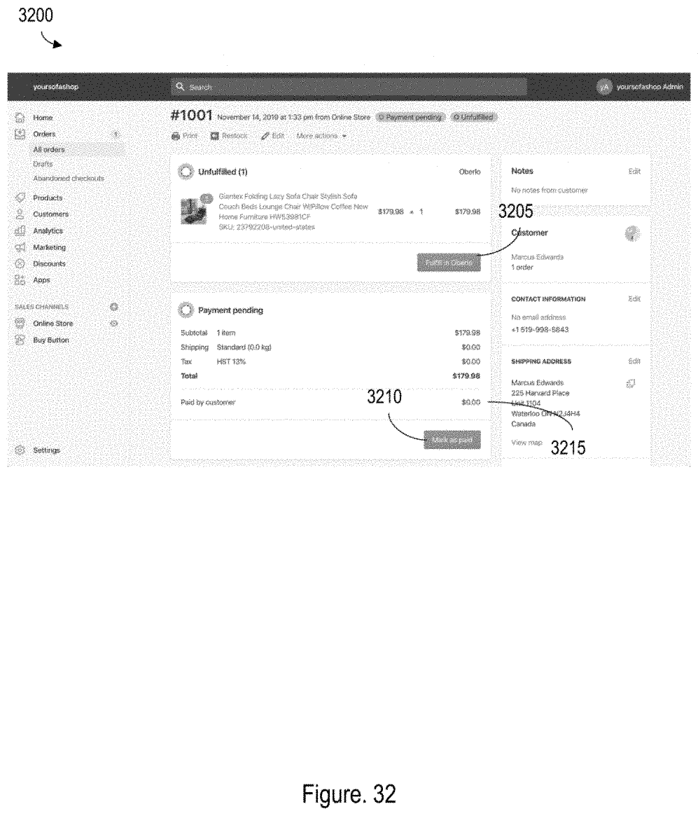

In the case of a product purchase, the Merchant Savings Server would provide the Product Supplier with information to identify the product, any additional product information such as colour, size, number of units of the product, customer information and customer shipping information, and means of payment, such as credit card or bank account information. In some implementations, the means of payment may be sent in the form of an electronic payment certificate. Confirmation of the order may be made, for example, through an interface screen similar to FIG. 28. The Product Supplier would then respond with an acknowledgement of the purchase, for example as in FIG. 25, initiate the product shipping procedures and process the payment or electronic payment certificate. Order acknowledgement may occur inside the application, and/or via a messaging interface such as email, text or equivalent such as the email message shown in FIG. 29. Other tools for testing aspects of the savings system may include testing modules to confirm the proper operation of the system, such as the tool shown in FIG. 31, and order tracking tools such as the one shown in FIG. 32.

In the case of a budgeting process for a product or group of products, the same product information as in a product purchase may be sent from the Merchant Savings Server, but additionally the parameters pertaining to the term and conditions of the budgeting process are sent. These parameters may include information regarding the required product availability time(s), planned time at which the savings plan will have sufficient funds to complete the transaction, a selection of options including what is to be done with the product should the savings plan not be completed, availability windows should the plan be accelerated or extended, and information regarding what action should be taken should the Product Supplier be unable to meet their commitment.

The Savings Plan Institution 306, is connected to the Merchant Savings Server for the purpose of creating and managing a Savings Plan Account. In one embodiment, the Savings Plan Institution is a separate financial entity, like a bank or trust account, and provides an online API to enable the creation and management of savings accounts, and payments from those accounts. In other implementations, the Savings Plan Institution is an institution that has been selected, and an account provided for this purpose by the Client. In other implementations, the client is provided a secure window within the budgeting setup process to access the user interface of the Savings Plan

Institution, and then to return to the remainder of the budgeting setup process. Independent of the account setup strategy, the Savings Plan Institution holds the funds on behalf of the Client, and on request reports the amount of money currently in the account. Should the client require the money saved in the savings account, the Client may directly access the account at the Savings Plan Institution. This provides a reassurance to the Client that the money that they are saving is under the Client's control, and the Client does not need to rely on the vendor to refund any saved money.

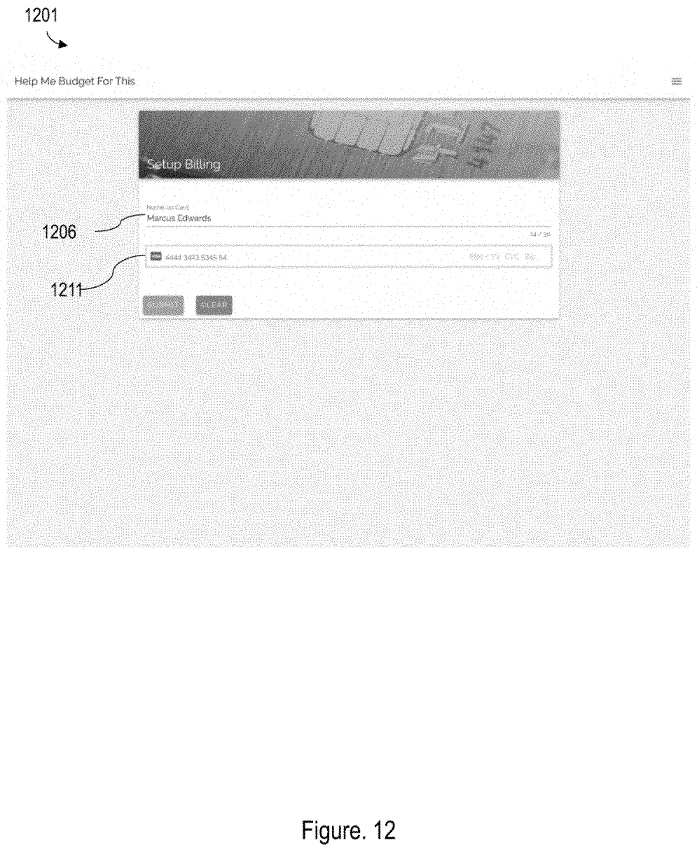

The Merchant Savings Server 303 is also connected to a Spending Account 307. The Spending Account is the account that is the source of funds to be supplied to the budgeting process. In some embodiments, the Client may authorize periodic payments to be withdrawn from the Spending Account and deposited in the Savings Plan Account in the Savings Plan Institution 306. In other embodiments, the source of funds may be a number of accounts at different institutions, or selected from a number of payment means. These payments may be authorized through an API that is offered from the financial institution that holds the Spending Account. In other embodiments, a periodic payment may be set up with the financial institution that holds the Spending Account, to directly transfer funds to the Savings Plan Institution. The setup of a source of funds is shown in FIG. 12.

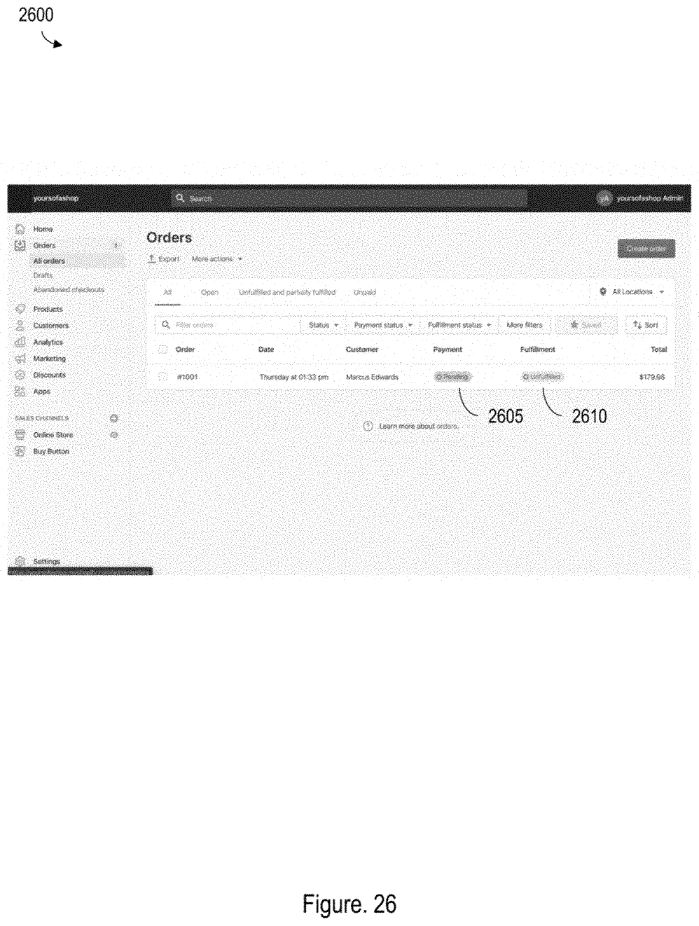

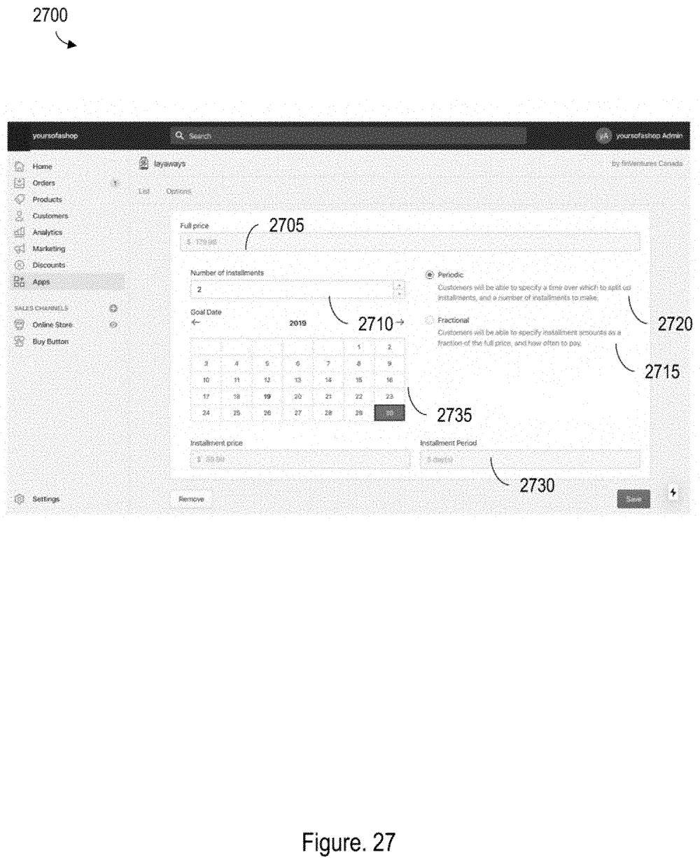

All of the transactions associated with the budgeting process associated with each purchase are recorded in the Savings Database 305 for interrogation by the Client 302 and by the Product Supplier 304. In some embodiments, periodic messages are sent from the Merchant Savings Server 303 to the Client to inform and encourage continued progress towards the savings goal. These messages may be either in-app or by some other channel such as email or text. Similarly, periodic messages may be sent from the Merchant Savings Server to the Product Supplier, to assure that the savings plan is on track, and that the item should be available for shipment at a specific time in the future. In some embodiments, the messages sent to the Customer may be used as a reminder to perform an anticipated task, such as making an additional contribution to the Savings Account from another source of funds. Monitoring of the status of the Savings Plan may be made through a vendor monitoring interface, for example, the one shown in FIGS. 26 and 27.

When the funds in the Savings Account are equal to or greater than the Purchase Price, the purchase of the item from the Product Supplier may be initiated. The Merchant Savings Server initiates a transfer of funds from the Savings Plan to the Product Supplier, requests delivery of the product according to the Client's delivery information and sends a message to the Client informing of the purchase. The Product Supplier may also send an additional message indicating a confirmation of the shipping details directly to the Client, or through the Merchant Savings Server.

In some embodiments, there is a merchant savings server for enabling a plurality of clients to save for a common savings goal. The server includes a receiving module configured to receive from a first client device an electronic invite to join a savings plan to transfer electronic funds to a joint savings account. The receiving modules is also configured to receive an electronic acceptance from the at least one additional client device. The system provides that the electronic acceptance includes an electronic funds transfer amount and a frequency to transfer the electronic funds to the joint savings account. The system also includes a transmitting module configured to send the electronic invite to at least one additional client device. The system also includes a judgement module configured to determine a balance the respective electronic fund transfers of the client device and the at least one additional client device to the joint savings account. The system provides that the savings plan is based on a series of electronic fund transfer into the savings account to accumulate funds equal to an indicated price of an item. The judgement module is also configured to automatically transfer electronic funds from the savings account when the savings account has accumulated electronic funds equal to the indicated price of the item.

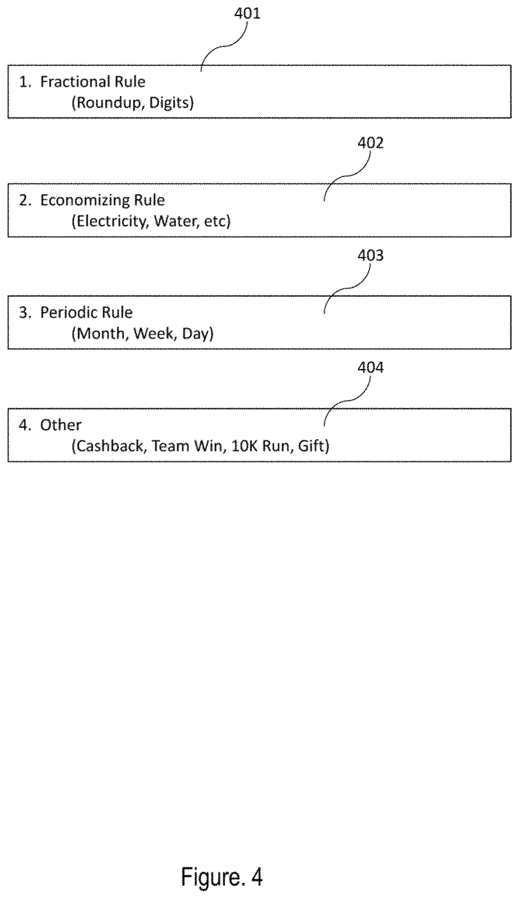

FIG. 4 illustrates a number of rules that may be used to calculate the contributions to the Savings Account from a number of sources. These methods or sourcing funds may be used individually or in combination to achieve the desired Savings Account goal. The Fractional Rule 401, calculates the difference between an item purchased through the Spending Account, and compares the purchase price to a next higher denomination, such as the next size fiat banknote or the next digit of rounding. Thus the ‘change’ from that transaction is virtually deposited into the Savings Account. The Economizing Rule 402, compares category expenditures for regular purchases, such as electric power, entertainment, transportation, shopping, dining, travel, education and calculates the amount over or under budget. If under budget, the amount under budget may be transferred to the Savings Account. This has the advantage of encouraging frugal spending habits, and experiencing the reward of having the goal of the item purchase occur sooner. The Periodic Rule 403, is a relatively simple rule that creates periodic withdrawals from the Spending Account and corresponding deposits to the Savings Account of specific amounts. These withdrawals may be of a specified uniform amount, or they may be increasing or decreasing according to a formula, depending on the budgetary needs of the Client. The Other Rule 404, may include a variety of other funds transfer triggers with associated amounts, including such trigger events as getting a cashback bonus for another purchase, having a favourite sports team win, accomplishing a personal goal such as weight loss or completing a goal such as a 10K run, or a received gift. The trigger criteria may be set up beforehand, along with the method of measurement to detect the triggers. These rules may be automated by various methods, including monitoring internet for news items, monitoring personal activity software for accomplishments, monitoring a bank account for atypical activity, or other such means.

In some embodiments, there is a computer implemented method of automatically electronically transferring funds. The method includes determining on a computer processor whether the customer has sufficient credit to transfer electronic funds equaling an indicated price of an item. The method also includes providing a computer input device for a customer to select a savings plan, wherein the savings plan is based on a series of automatic electronic fund transfers into an savings account to accumulate funds equal to the indicated price. The method also includes storing instructions on a computer readable memory to initiate transfer of electronic funds when the computer processor determines the savings account has sufficient funds to transfer electronic funds equaling the indicated price.

The methods provided herein are not contemplated to be performed without a computer and a system of computers.

It is apparent that the use of the computer processor, computer input device, and computer readable memory as described herein transfers funds using less processing power (e.g., with fewer instructions) than known methods, while providing electronic funds transfer of the same or improved quality and degree. Thus, the computer processor, computer input device, and computer readable memory as described herein, in combination with the computer, solves a computer problem.

FIG. 5 shows an exemplary user interface screen that a Client would see as a status screen for the parameters of the Savings System. The Savings Plan ID 501, displays a unique identifier for the Savings Plan. This plan identifier is assigned by the Merchant Savings Server through well known methods. The Purchase Item 502, is a text identifier based on the product information selected by the Client from the Client Web Browser. The text is normally human readable, and allows the Client to recall what item is being saved for. The Purchase Price 503, is the price of the item. In a preferred embodiment, there is an agreement or contract between the Client and the Product Supplier that the item will be available for purchase at the agreed time and at no greater than the Purchase Price. The Time for Purchase 504, is the time at which the funds are predicted to be available to purchase the item. In a preferred embodiment, this is a fixed time. In other embodiments, this time may be a range of times. This range of times may be calculated by reviewing the Client's Spending Account and the various contribution Rules (Drawing 4: 401-404) and using predictive Artificial Intelligence to predict both the most likely Time for Purchase and the range of probable variance. The Verified Available field 505, is a binary field indicating if the Product Supplier has ensured that the item selected will be guaranteed to be available at the Time for Purchase. The Savings Account ID 506, is an identifier for the Savings Account associated with this Savings Plan. In one embodiment, this number is the same as the account number at the Savings Plan Institution. The Institution 507, is a unique identifier referencing the Savings Plan Institution. The Savings Strategy Parameter 509, identifies one or more of the contribution Rules (Drawing 4: 401-404) that are in place, and any associated parameters. The On Savings Early 510, indicates one of several actions that are to be taken if the Purchase Price is reached earlier than the Time for Purchase. Options in the preferred embodiment include ‘Purchase Early’, Wait and Collect Interest', ‘Request Item Upgrade’. The On Savings Time Expiry 511, indicates what action should be taken if the Purchase Price is not saved before the Time for Purchase. Options in the preferred embodiment include ‘Abandon and refund savings to date’, ‘Select alternate product’, and Ask product supplier for time extension'.

In some embodiments, there is a computer implemented method for automatically electronically transferring funds. The method includes providing a computer input device for a customer to select an item with an indicated price. The method also includes determining on a computer processor whether the customer has sufficient credit to transfer electronic funds equal to the indicated price. The method also includes displaying on a customer computer display device at least one additional payment option if the customer has insufficient credit to transfer electronic funds equal to the indicated price. The method provides that the at least one additional payment option includes initiating a savings plan to transfer electronic funds to a savings account for to accumulate electronic funds equal to the indicated price at a future date.

The method may also include storing instructions on the computer readable memory to initiate a purchase of the item when the savings account has sufficient funds to purchase the item.

The method may provide that the savings plan is based on a series of automatic electronic fund transfers into the savings account according to the savings plan,

The method may provide that the at least one additional payment option includes a partial immediate electronic fund transfer less than the indicated price and a savings plan to transfer electronic funds at a future date to a savings account equaling a remaining amount equal to the difference between the partial immediate fund transfer and the indicated price.

The methods provided herein are not contemplated to be performed without a computer and a system of computers.

It is apparent that the use of the computer processor, computer input device, customer display device, and computer readable memory as described herein transfers funds using less processing power (e.g., with fewer instructions) than known methods, while providing electronic funds transfer of the same or improved quality and degree.

Thus, the computer processor, computer input device, and computer readable memory as described herein, in combination with the computer, solves a computer problem.

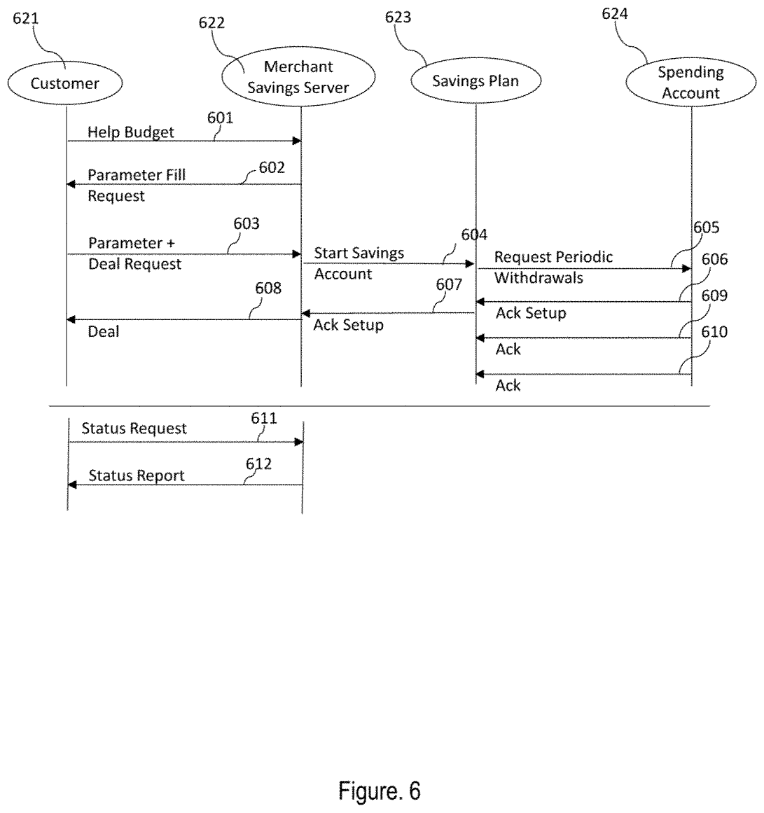

FIG. 6 shows messaging types between a Client, the Merchant Savings Server, the Savings Plan Institution, and the Spending Account. The Client initiates the Savings Plan process by selecting ‘Help me budget for items’ on the client interface. This selection generates a ‘Help Budget’ message 601, that is sent to the Merchant Savings Server. The Merchant Savings Server responds with a ‘parameter fill request’ message 602, that requests the user to supply information required for the Savings Plan, such as the information in FIG. 5. Once the information is entered, the Client Web Browser responds with the information in a ‘Parameters and deal request’ message 603. To continue the process, the Merchant Savings Server sends a ‘Start savings account’ message 604, to the Savings Plan Institution, to establish a savings account for the purpose of this purchase. In one embodiment, the Savings Plan Institution sends a message 605 to the Spending Account Institution to request periodic transfers from the Spending Account to the Savings Plan Account. For other embodiments, where the funds transfer rules are less regular or more complex, the Merchant Savings Server may send messages (not shown) directly to the Spending Account Institution for individual funds transfer events over the course of the Savings Plan. The Spending Account Institution responds to the withdrawal requests by sending an ‘Ack setup’ 606, 607 message acknowledging that the transfers are authorized. The acknowledgement may happen between the Savings Plan Institution and the Spending Account Institution, or between the Merchant Savings Server and the Spending Account Institution as previously discussed. The Merchant Savings Server confirms with either an interrogation (not shown) of the Product Supplier, or though interrogating an internal database that the Product Supplier will honour the delivery of the item at the Purchase Price at the Time for Purchase. The Merchant Savings Server then relays the combined status of the contract for delivery at a future time with the acknowledgement of the successful setup of the Savings Plan in a Deal' message 608 to the Client

At any time after the setup process above is complete, the Client may initiate a ‘Status request’ message 611 to the Merchant Savings Server to interrogate as to the status of the Savings Plan on the Savings Database. In a preferred embodiment, the Merchant Savings Server responds with a ‘Status report’ 612.

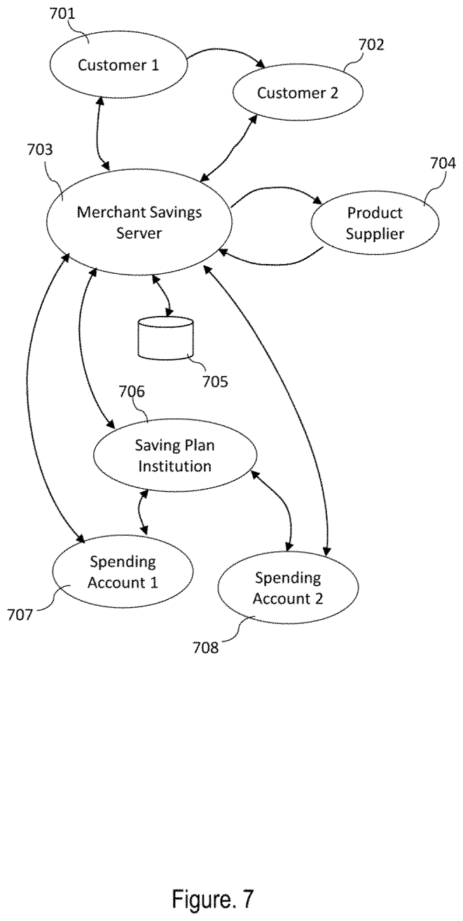

FIG. 7 shows a possible implementation where more than one customer is saving for a purchase. Client 1 701,is a first client. Client 2 702,is a second client. In one embodiment, the Savings Plan for a particular item is started by one of the Clients, and that client invites the second client to join into the Savings Plan by giving the second client the Savings Plan ID. This process may be generalized to more than two clients, and would be suitable for savings goals that span larger groups such as families or communities. As in previous examples, both Client 1 and Client 2 communicate with a Merchant Savings Server. This permits each Client to view the progress and status of the Savings Plan, including each other's contributions. The Merchant Savings Server may be either a single computer executing computer instructions, or may be a network of computers connected to the internet and to a Savings Database 705. The Product Supplier 704 is communicatively connected to the Merchant Savings Server for receiving product inquiries and confirmation of product delivery contracts. The Savings Plan Institution 706 holds a savings account that may be contributed to by a plurality of spending accounts, here shown as an example, Spending Account 1 707, and Spending Account 2 708. In one example, the first Client to set up the information in FIG. 5 normally. Subsequent contributors to the same Savings Plan would have some fields unchangeable, such as Savings Plan Goal, but would be able to set some fields individually. Individually settable fields would include Savings Strategy, Saving Strategy Parameter, and the source or Spending Account (not shown). With additional Clients contributing to the savings plan, the Time for Purchase and associated range would be recalculated by a similar Al engine as for a single Client. The messaging to initiate and manage the savings plan could be through email, through a direct messaging platform, or through a social media channel such as Facebook or Google.

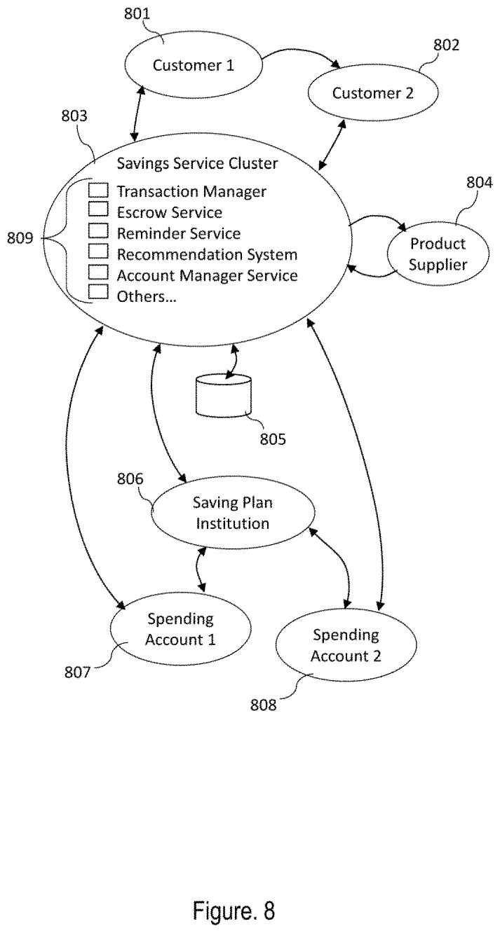

FIG. 8 shows an implementation where the Merchant Savings Server is composed of a cluster of microservice servers 803. In a corresponding embodiment, these microservices form a high-available server mesh infrastructure that may respond to client load by scaling the resources allocated to the individual microservices 809 that are under the heaviest load. The microservices 809 may communicate using a high-efficiency message bus technology such as RabbitMQ, Kafka or simply using HTTP(S). In corresponding embodiments, the Merchant Savings Server 803 architecture is extendable such that additional services may be introduced to the server cluster and begin to serve customers effectively immediately. Microservices 809 that may exist would individually implement separable elements of the Merchant Savings Server cluster's overall functional purpose. Possible examples include a Reminder Service, Transaction Manager Service, Escrow Service, Account Management Service, Escrow Service, and others.

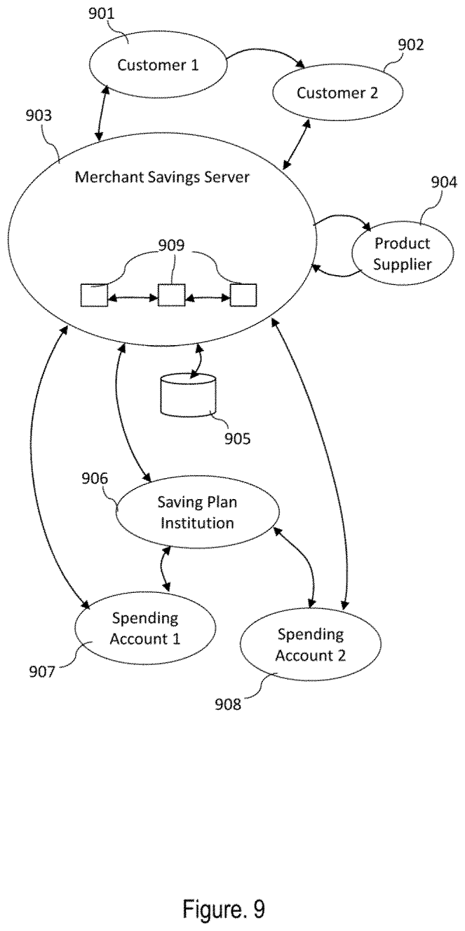

FIG. 9 illustrates the different protocols that enable communication between all of the system's elements. Protocol 901 facilitates customer-to-customer interactions, such as the interaction necessary for two customers to save for an item together. This protocol could be via either a messaging service provided for users within a store interface, or an existing messaging service such as SMS or email. Protocols 902, 903 facilitate the interactions of customers with the Merchant Savings Server. 902, 903 may include two protocols: one for incoming queries and responses, and one for server-initiated communications such as reminders and other notifications. In some embodiments, 902 and 903 may be implemented on the the same communications channel. For a few examples, 902 may be embodied by a JSON, SOAP, XML or GraphQL based API. Protocol 903 may be embodied by SMTP, automated SMS and/or a push notifications system for communication with mobile devices, or other such protocols. In one embodiment, protocol 901 may be simulated by protocols 902, 903 where the Merchant Savings Server itself facilitates the communication between the customers using these protocols 902, 903. Protocol(s) 904 facilitates communication between the Merchant Savings Server and Product Supplier(s). 904 represents a set of protocols necessary for communicating with Product Suppliers across different industries and different communication sophistication. For example, some suppliers may only take phone orders. Others may have RESTful APIs that are either internal or external. Still more may have advanced GraphQL APIs or similar. Communication protocol 905 facilitates database communication. Protocol 905 may be implemented as the ubiquitous Open DataBase Connectivity protocol (ODBC), the similar Java DataBase Connectivity protocol (JDBC) or Microsoft's more advanced OLE-DB protocol, for example. Protocol 906 facilitates communication between the Merchant Savings Server and financial institution(s). Banks have begun to adopt modern web-based communication mechanisms, such as Scotiabank's open source RESTful JSON API, a client for which is available to developers on GitHub. However, other protocols which are specific to the industry such as SWIFT or ISO20022 may be used to facilitate communication with financial institutions and perform EFTs, Savings Account creations, etc. Protocol 907 represents the internal communication mechanism between the institution and any Savings Accounts. Its depiction serves to emphasize that while the Merchant Savings Server may also interact with these accounts directly, it must delegate some account interactions, such as account creation, to be executed by an external financial institution. Protocol 908 represents those communications which are not heavily dependent on the internal mechanisms of a financial institution. For example, some institutions provide straightforward APIs for reading and even manipulating account information directly to their customers that circumvent some of the traditional complexity of account management.

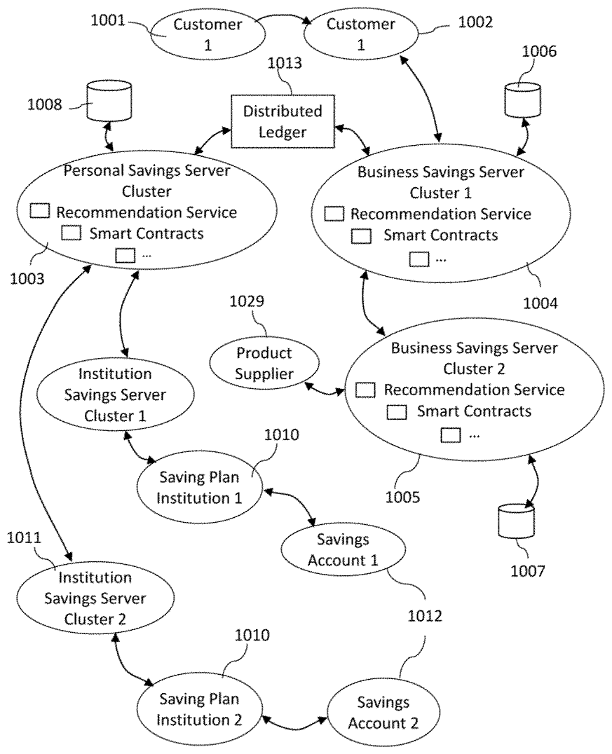

FIG. 10 illustrates an embodiment where the Merchant Savings Server 1003, 1004, 1005, 1011 is composed of a number of distributed server clusters. Each cluster may be maintained by an individual participant in the network and itself be composed of microservices that pertain to the specific elements of the savings plan system that are most relevant to the corresponding participant. Participants include customers 1001, 1002, Product Suppliers 1009 and financial institutions 1010. The microservices composing the type of cluster 1011 maintained by a financial institution 1010 may, for example, contain Smart Contracts Services, Account Management Services and Transaction Management Services, but not a Reminder Service since reminders are useful for motivating individuals and not large corporations. Three basic types of clusters are Personal Clusters 1003, Business Clusters 1004 and Institution Clusters 1005. The distributed server architecture in corresponding embodiments may remain in-sync and share transaction related information via a Distributed Ledger technology 1013. The Distributed Ledger 1013 may be managed using a new distributed blockchain technology. This blockchain technology would have the three traditional blockchain components: distributed data structure (the Distributed Ledger), consensus algorithm (a Proof of Stake variant) and network (the network architecture discussed here). As with most blockchain 2.0 technologies, Smart Contracts play a role. In this case, Smart Contracts embody the Savings Plan logic. A Proof of Stake consensus variant where individuals have “scoped stake” in only those markets which they have demonstrated interest in by either starting a Savings Plan towards a future goal, or purchasing items in the past, facilitates the honest maintenance of the Distributed Ledger 1013 since users who have vested interest in a market are the ones who may most easily publish the relevant transaction records in blocks. These same users are the most unlikely to choose to invalidate the records pertaining to the items they wish to acquire.

FIG. 11 shows a user interface for a customer log in screen, in accordance with an embodiment. The user interface 1101 includes a username field 1106 and a password field 1111. A customer may log to access a customer account for the savings plan by entering a username and password associated with the customer account and pressing the log in button 1116.

FIG. 12 shows a user interface for a customer savings account set up page, in accordance with an embodiment. The user interface 1201 displays a name field 1206 for entering the customer's name on a customer's bank card. The user interface also displays a source account access number entry 1211 for associating a method of payment, such as a customer's credit card, with the customer savings account.

FIG. 13 shows a user interface for setting up a savings item in a savings plan, in accordance with an embodiment. The user interface 1301 may display any number of savings items 1306 which a customer may create a savings plan for. For each savings item 1306, a price 1311 associated with the item is also displayed.

FIG. 14 shows a user interface for setting up a customer savings plan, in accordance with an embodiment. The user interface allows a customer to log in to access a registration form. The user interface 1401 includes a username field 1306 and a password field 1411. A customer may log in to access a customer registration form for the savings plan by entering a username and password associated with the customer account and pressing the log in button 1416.

FIG. 15 shows a user interface for initiating a savings plan, in accordance with an embodiment. The user interface 1501 is shown when a user has insufficient funds, insufficient credit, or both. The “continue” button 1506 allows a user to initiate setting up a savings plan account.

FIG. 16 shows a user interface of a supplier administrator landing screen for setting parameters of the savings plan, in accordance with an embodiment. The user interface 1601 provides a products button 1606 to allow a supplier administrator to select which products may be purchased using a savings plan.

FIG. 17 shows a user interface of a supplier administrator landing screen for management of current savings plan offers, in accordance with an embodiment. The user interface 1701 displays products 1706 which may be purchased using a savings plan. The price 1711 of the product is also displayed in the user interface 1701.

FIG. 18 shows a user interface for a customer when visiting an online store, in accordance with an embodiment. The online store may allow customers to purchase an item using a computer implemented method of providing a customer with an alternative method of purchasing the item.

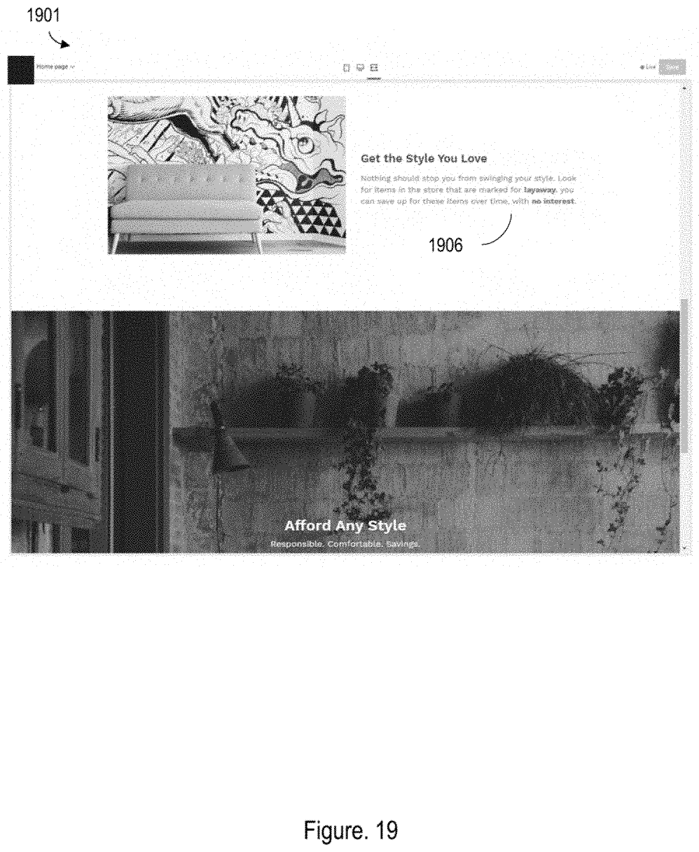

FIG. 19 shows another user interface for a customer when visiting an online store, in accordance with an embodiment. The user interface 1901 displays information 1906 on savings plan options when purchasing items on the online store.

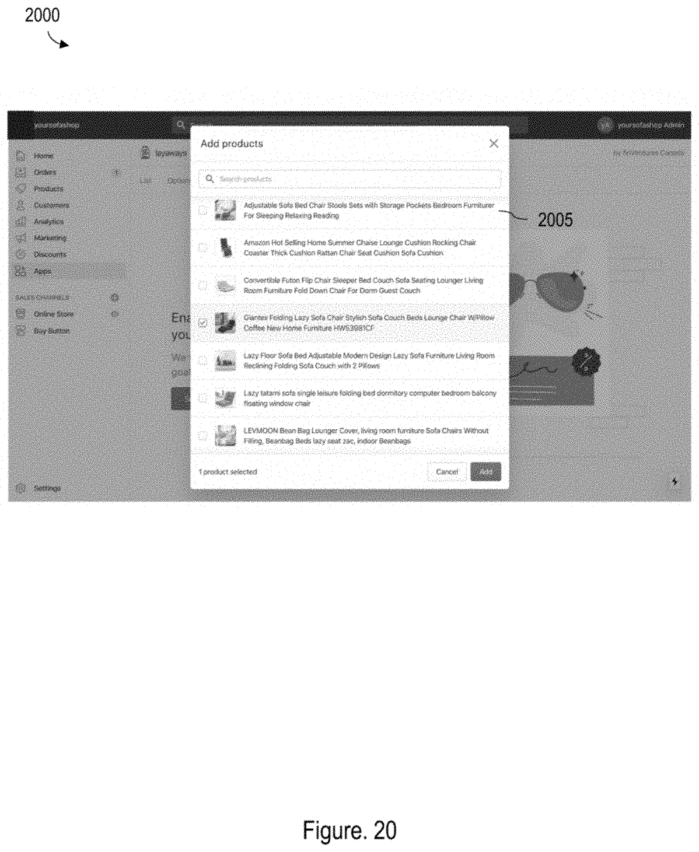

FIG. 20 shows a user interface for selecting items which may be purchased on an online store using a savings plan, in accordance with an embodiment. The user interface 2000 displays items 2005 which are listed on the supplier's online store and user may individually or collectively select items which may be purchased by a customer using a computer implemented method of providing a customer with an alternative method of purchasing the item provided herein.

FIG. 21 shows a user interface for setting up options for a savings plan, in accordance with an embodiment. The user interface 2100 displays a full price of the item 2105 to be offered for purchase using a savings plan. The supplier may select the number of installments to purchase the item 2110 and whether the installments are fractional 2115 or periodic 2120. Fractional installments 2115 allow customers to specify amounts saved in each installment towards to purchase of the item. Periodic installments 2120 allow customers to specify a time frame or goal date 2130 to save to purchase an item. The user interface 2100 allows for selecting time frame 2125 for saving the installments. While weekly and monthly time frames are shown, any period of time may be used for saving installments. The supplier may also set the price saved 2135 by the customer in each installment.

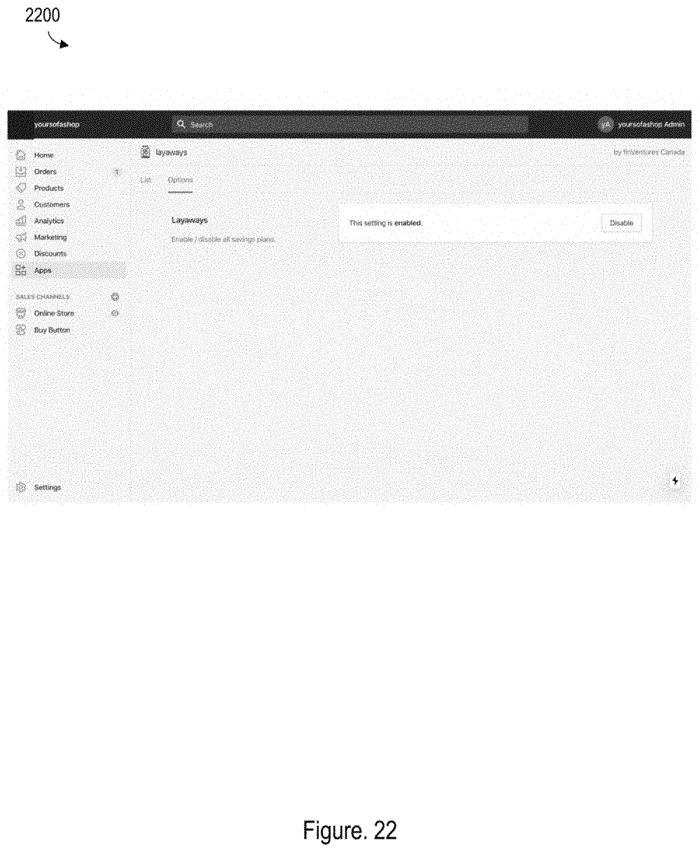

FIG. 22 shows a user interface for setting global options for a savings plan for purchasing items on a supplier's online store, in accordance with an embodiment. The user interface 2200 allows a supplier to choose to enable a savings plan for all items purchased through the supplier's online store. Accordingly, a supplier may choose to disable a savings plan for all items purchased through the supplier's online store.

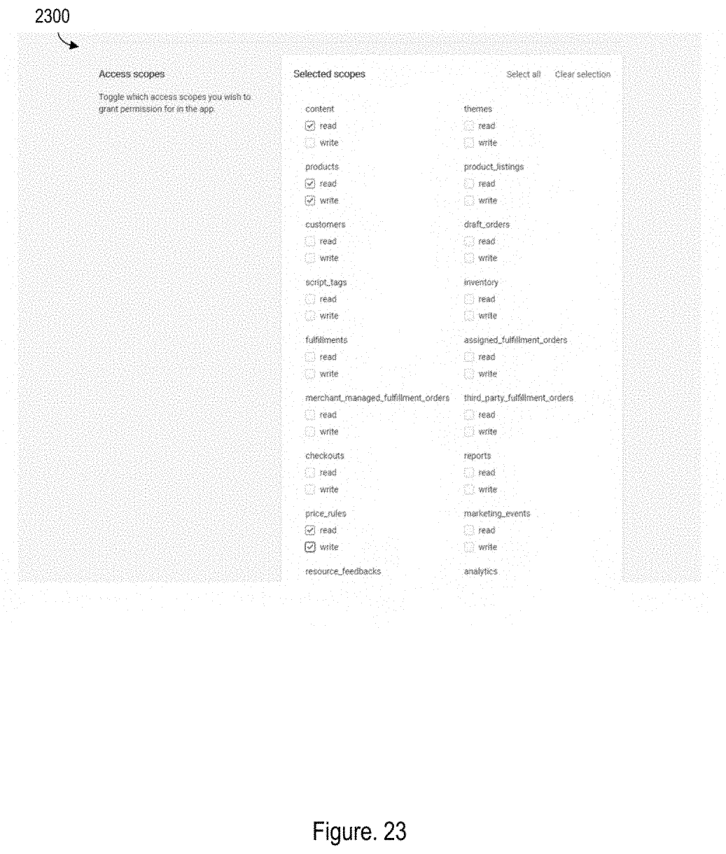

FIG. 23 shows a user interface for setting up GraphQL API options on a supplier online store, in accordance with an embodiment. The user interface 2300 may use any communications protocol may be used by the user interface 2300 to communicate between the customers and the Merchant Savings Server including, without limitation, JSON, SOAP, XML, or GraphQL.

FIG. 24 shows a user interface to install a savings plan plugin, in accordance with an embodiment. The user interface 2400 allows for a supplier to install a plugin 2405 to operably connect the supplier's online store with the Merchant Savings Server to allow for offering items to be purchased by a customer using a savings plan.

FIG. 25 shows a user interface for confirming a customer order using a savings plan. The user interface 2500 displays the price of the item 2505 purchased using a savings plan on the customer order confirmation.

FIG. 26 shows a user interface for a supplier for monitoring an order for an item purchased by a customer using a savings plan. The user interface 2600 displays the payment status 2605 and fulfillment status 2610 of an order purchased by a customer from a supplier's website using a savings plan. The payment status 2605 may also display the number of installments remaining or the amount saved by the customer for the purchase of the item to date.

FIG. 27 shows another embodiment of the user interface for setting up options for a savings plan of FIG. 21, in accordance with an embodiment. The user interface 2700 displays a full price of the item 2705 to be offered for purchase using a savings plan. The supplier may select the number of installments to purchase the item 2710 and whether the installments are fractional 2715 or periodic 2720. Fractional installments 2715 allow customers to specify amounts saved in each installment towards to purchase of the item. Periodic installments 2720 allow customers to specify a time frame or goal date 2730 to save to purchase an item. The user interface 2700 allows for selecting time frame 2725 for saving the installments. While weekly and monthly time frames are shown, any period of time may be used for saving installments. The supplier may also set the price saved 2735 by the customer in each installment.

FIG. 28 shows a user interface displayed to a customer when confirming an order when purchasing with a savings plan, in accordance with an embodiment. The user interface 2800 displays customer information 2805, such as the customer's shipping address and contact information. The user interface 2800 also displays item name 2810 and price 2815 for an item purchased using a savings plan. The method of payment 2820 is displayed as being the savings plan.

FIG. 29 shows a user interface for an email confirmation of a customer order, in accordance with an embodiment. The user interface 2900 displays an email confirmation displayed when a customer purchases an item on a supplier's website using a savings plan. The email confirmation displays order information which includes without limitation the savings plan approval date 2905, a charge amount 2910, an approved usage limit 2915, and the first date of a recurring charge 2920.

In some embodiments there is a computer implemented method of ensuring that an item will be available at a specific time in the future. The method includes providing a customer computer input device for selecting the item. The method also includes displaying on a computer display device an indicated price for the item that is valid within a time period. The method also includes displaying on the customer display device an offer to purchase the time with a savings plan. The method may provide that the savings plan includes automatic electronic fund transfers to a savings account to accumulate the indicated price. The method may provide that the savings plan is structured to accumulate funds equal to the indicated price within the valid time period. The method also includes storing instructions on a computer readable memory for a production and delivery schedule to make the item available at the end of the production and delivery schedule. The method also includes determining on the computer processor a probable date on which the savings account will accumulate funds equal to the indicated price based on the savings plan. The method also includes physically sending the item to the customer at the end of the valid time period

The method may also include adjusting the production and delivery schedule on the computer processor if the savings account accumulates the indicated price ahead of the probable date.

The methods provided herein are not contemplated to be performed without a computer and a system of computers.

It is apparent that the use of the computer processor, computer input device, computer display device, and computer readable memory as described herein transfers funds using less processing power (e.g., with fewer instructions) than known methods, while providing electronic funds transfer of the same or improved quality and degree. Thus, the computer processor, computer input device, and computer readable memory as described herein, in combination with the computer, solves a computer problem.

FIG. 30 shows a user interface for tracking an order purchased using a savings plan, in accordance with an embodiment. The user interface 3000 displays the date of order 3005 by the customer purchasing the item using a payment plan. The user interface 3000 also displays the payment status 3010, indicating whether the payment using the savings plan has been completed or is still pending.

FIG. 31 shows a tool for testing a savings plan system with an order purchased using a payment plan, in accordance with an embodiment. The tool for testing generates a simulated order for the supplier which is not charge a customer. The tool allows the supplier to determine whether the savings plan system is operational. The user interface 3100 displays a payment plan renewal period 3105 for the simulated order. The user interface 3100 also displays an incremental payment amount 3110 to be charged at each renewal period 3105.

FIG. 32 shows a user interface for a tool for a vendor order processing console, in accordance with an embodiment. The user interface 3200 provides a “fulfillment button” 3205 for manually updating the order status as being fulfilled for an order purchased with a payment plan or savings plan. The user interface 3200 also provides a “mark as paid” button 3210 for manually updating the payment status of an order paid by a payment plan or savings plan. The user interface 3200 displays the amount the customer has currently paid 3215 through a purchase made using a payment plan or a savings plan.

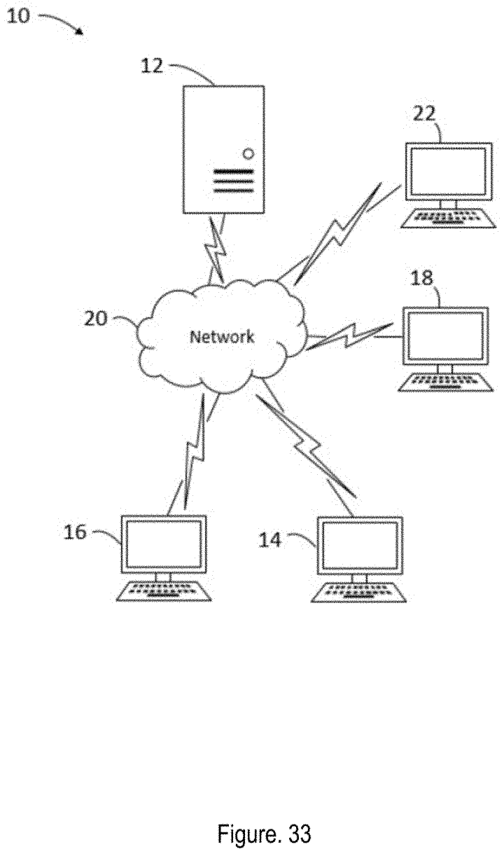

FIG. 33 shows a block diagram illustrating a system 10, in accordance with an embodiment. The system 10 includes a server platform 12 which communicates with a plurality of devices 14, 16, 18 via a network 20. The server platform 12 also communicates with a plurality of user devices 22. The server platform 12 may be a purpose built machine designed specifically for systems and methods as described herein.

The server platform 12, and devices 14, 16, 18, 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The devices 12, 14, 16, 18, 22 may include one or more of a memory, a secondary storage device, a processor, an input device, a display device, and an output device. Memory may include random access memory (RAM), content addressable memory (CAM) and Ternary CAM (TCAM) or similar types of memory. Also, memory may store one or more applications for execution by processor. Memory may also be used for data comparisons for routing purposes. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18, 22. For example, input device may be a keyboard, keypad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects may also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

In this description, devices 12, 14, 16, 18, 22 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

In response to receiving information, the server platform 12 may store the information in storage database. The storage may correspond with secondary storage of the device 12, 14, 16, 18, 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

Each device 14 may be associated with a particular user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

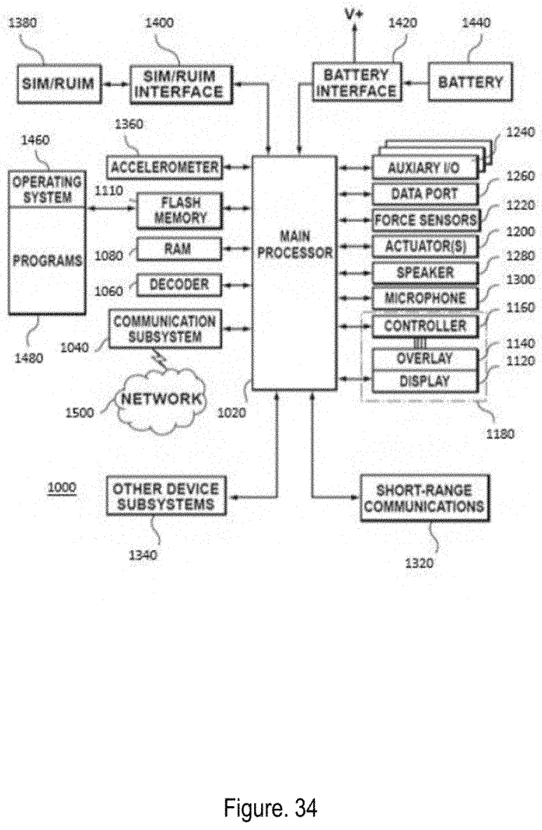

FIG. 34 shows a simplified block diagram of components of a device or portable electronic device 1000, according to an embodiment. The portable electronic device 1000 includes multiple components such as a processor 1020 that controls the operations of the portable electronic device 1000. Communication functions, including data communications, voice communications, or both may be performed through a communication subsystem 1040. Data received by the portable electronic device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The portable electronic device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360. The accelerometer 1360 may be utilized for detecting direction of gravitational forces or gravity-induced reaction forces.

To identify a subscriber for network access according to the present embodiment, the portable electronic device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The portable electronic device 1000 also includes an operating system 1460 and software components 1480 that are executed by the processor 1020 and which may be stored in a persistent data storage device such as the flash memory 1100. Additional applications may be loaded onto the portable electronic device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

While the above description provides examples of one or more apparatus, methods, or systems, it will be appreciated that other apparatus, methods, or systems may be within the scope of the claims as interpreted by one of skill in the art.

1. A computer system for automatically electronically transferring funds, the system comprising:
a computer display device displaying a user interface configured to provide the customer with a computer input device to create a savings plan to purchase an item with an indicated price, wherein the savings plan is based on a series of electronic fund transfers into a savings account to accumulate electronic funds in the savings account equaling the indicated price; and
a computer server further comprising:
a computer processor configured to determine if the customer has sufficient funds or sufficient credit to electronically transfer funds equaling the indicated price; and
computer readable memory with stored instructions to initiate a purchasing action to purchase the item for the customer when the savings account has sufficient funds to purchase the item.

2. The system of claim 1, wherein the item is at least one of the group comprising goods and services.

3. The system of claim 1, wherein the computer readable memory further includes stored instructions to periodically send electronic messages to the customer reminding the customer to contribute to the savings account.

4. The system of claim 1, wherein the series of payments includes a contribution amount which is determined by the computer processor based on whether a customer is underbudget in one or more spending categories.

5. The system of claim 1, wherein the series of payments includes a contribution amount which is determined by the computer processor based on the occurrence of an event relevant to the customer.

6. The system of claim 1, wherein the series of payments includes a contribution amount which is determined by the computer processor based on a future event specified by the customer.

7. The system of claim 1, wherein the series of payments includes a contribution amount which is determined by the computer processor based on whether the customer has won or lost a bet.

8. A computer implemented method of automatically electronically transferring funds, the method comprising:
determining on a computer processor whether the customer has sufficient credit to transfer electronic funds equaling an indicated price of an item;
providing a computer input device for a customer to select a savings plan, wherein the savings plan is based on a series of automatic electronic fund transfers into an savings account to accumulate funds equal to the indicated price; and
storing instructions on a computer readable memory to initiate transfer of electronic funds when the computer processor determines the savings account has sufficient funds to transfer electronic funds equaling the indicated price.

9. The method of claim 8 further comprising determining on a computer processor that the customer does not have sufficient funds to purchase the item.

10. A computer readable memory having recorded thereon statements and instructions for execution by a computerized electronic funds system to carry out the method of claim 8.

11. The method of claim 8 further comprising periodically sending electronic messages from a computer server reminding the customer to contribute to the savings account.

12. The method of claim 8, wherein the series of payments includes a contribution amount which is determined by a computer processor based on whether a customer is underbudget in one or more spending categories.

13. The method of claim 8, wherein the series of payments includes a contribution amount which is determined by a computer processor based on the occurrence of an event relevant to the customer.

14. The method of claim 8, wherein the series of payments includes a contribution amount which is determined by a computer processor based on a future event specified by the customer.

15. The method of claim 8, wherein the series of payments includes a contribution amount which is determined by a computer processor based on whether the customer has won or lost a bet.

16. The method of claim 8, wherein the series of payments includes a contribution amount which is a related to a periodic charge.

17. A computer implemented method for automatically electronically transferring funds, the method comprising:
providing a computer input device for a customer to select an item with an indicated price;
determining on a computer processor whether the customer has sufficient credit to transfer electronic funds equal to the indicated price; and
displaying on a customer computer display device at least one additional payment option if the customer has insufficient credit to transfer electronic funds equal to the indicated price, wherein the at least one additional payment option includes initiating a savings plan to transfer electronic funds to a savings account for to accumulate electronic funds equal to the indicated price at a future date.

18. The method of claim 17 further comprising storing instructions on the computer readable memory to initiate a purchase of the item when the savings account has sufficient funds to purchase the item.

19. The method of claim 17, wherein the savings plan is based on a series of automatic electronic fund transfers into the savings account according to the savings plan,

20. The method of claim 17, wherein the at least one additional payment option includes a partial immediate electronic fund transfer less than the indicated price and a savings plan to transfer electronic funds at a future date to a savings account equaling a remaining amount equal to the difference between the partial immediate fund transfer and the indicated price.
